(19) United States
(12) Patent Application Publication
(10) Pub. No.: US 2018/0272825 A1
(43) Pub. Date: Sep. 27, 2018

(54) Improved Vehicle

(71) Applicant: Eagleton IP Technology Limited, Bayview, Auckland (NZ)

(72) Inventor: John Eagleton, Bayview, Auckland (NZ)

(21) Appl. No.: 15/764,618

(22) PCT Filed: Sep. 30, 2016
(86) PCT No.: PCT/NZ2016/050160

§ 371 Date: Mar. 29, 2018

(30) Foreign Application Priority Data
Sep. 30, 2015 (NZ) 712764

(51) Int. Cl. B60G 17/027; B62D 21/02; B60G 3/14; B62D 63/08; B60D 1/54

(52) U.S. Cl. CPC B60G 17/0272; B62D 21/02; B60G 3/14; B62D 63/08; B60D 1/54; B60P 3/0255; B60G 2202/12; B60G 2202/41; B60G 2300/04; B60G 2500/30; B60G 2200/13

(57) ABSTRACT

This invention relates to a chassis system for a vehicle comprising a frame configured to support a body of the vehicle. The frame comprises a pair of outer longitudinal members defining outer lateral sides of the chassis system. One or more suspension systems are connected between each of a plurality of wheel mounts and the frame, the wheel mounts configured such that the chassis system is supported on at least one pair of wheels. The outer longitudinal members are positioned on the outside of and adjacent to the wheels when the frame is in a ride position. The suspension systems are configured to selectively vary the height of the frame between the ride position and a raised position in which the outer longitudinal members are at a height above the top of the wheels.

### FIELD OF INVENTION

The present invention relates to a vehicle. More particularly, the invention relates to a vehicle providing a large, readily accessible and visible mobile interior. In some embodiments the invention relates to an improved trailer.

### BACKGROUND TO THE INVENTION

There are many situations in which a mobile interior is useful.

Many traders find it useful to have a mobile structure with an interior from which they can sell or display their goods, or provide services such as food preparation and sale. The mobility allows them to travel to customers, for example where people congregate for events.

A common solution is a truck or trailer containing the trader's goods or equipment. The truck or trailer can be driven or towed between the locations at which the trader sells their goods or provides their services. Typical trucks or trailers used for this purpose have hatches on one or more sides that so that customers can see into the truck or trailer to view the trader's goods and/or interact with the trader.

Sometimes a mobile interior is used to display items or information. In this case a truck or a trailer having one or two side-hinged doors is often used, and people can walk through the interior of the truck or trailer and view the items or information on display.

A problem with existing trucks or trailers used when a mobile interior is required is a lack of accessibility. It is often difficult for people to easily see into the entire interior from the outside, and/or enter and exit it. It would be advantageous if there was a mobile interior that could be used for the purposes of trading goods, providing services, or displaying other items or information, while being more readily accessible and visible from the outside.

Another problem with many existing solutions is that the available interior floor area is small, being limited by the outer dimensions of the truck or trailer. It would be advantageous if there was a mobile interior that was able to easily provide a large floor area on which a trader's goods or other items or information could be placed or displayed. Additionally, many existing solutions are not able to provide a low floor height. It would be advantageous if there was a mobile interior that was able to provide the interior floor area at a low height to enable easy access.

### OBJECT OF THE INVENTION

It is an object of the invention to provide an improved mobile interior that is easily accessible, easily visible from the outside, having a low floor height and/or having a large floor area.

Alternatively, it is an object of the invention to address at least some of the foregoing problems or at least provide the public with a useful choice.

### SUMMARY OF THE INVENTION

According to a first aspect of the invention, there is provided a vehicle comprising:
a body having sides, an interior and an opening on at least one of the sides, the opening being coverable by an upper panel and a lower panel, the upper panel and the lower panel able to pivot between open and closed positions, the upper panel able to pivot at its upper edge, the lower panel able to pivot at its lower edge;
wherein the lower panel in the open position forms a platform extending from the opening, and the upper panel in the open position provides cover over at least some of the platform.

Preferably the vehicle is a trailer and comprises means for connecting the trailer to a towing vehicle, for example a drawbar.

Preferably, the interior comprises a lower surface, and wherein, when in the open position, the platform is substantially parallel to, and substantially at the same height as, the lower surface of the interior.

Preferably, the lower surface of the interior is lower than the top of wheel wells of the vehicle.

Preferably, the lower panel is able to receive or release legs with which the lower panel can be supported off the ground. In some embodiments the height of each leg is adjustable.

Preferably, the lower panel is substantially the same size as the opening.

Preferably, the upper panel is at least as large as the lower panel.

Preferably, the lower panel in the closed position forms a seal with the opening. In some embodiments the lower panel in the closed position forms a seal with a recessed surface or lip within the opening.

Preferably, the upper panel in the closed position seals to the opening.

Preferably, the outer face of the lower panel in the closed position is flush with, or internal to, the outer surface of the body of the vehicle.

Preferably, the outer face of the upper panel in the closed position is flush with the outer surface of the body of the vehicle.

Preferably, the hinges connecting the lower and upper panels to the side of the vehicle are hidden or recessed within the vehicle.

Preferably, the vehicle has a length, width and height, the sides of the vehicle defined by the length and the height, the back defined by the width and the height and the length larger than the width and the height.

Preferably, the opening is located on a side of the vehicle defined by the length and the height of the vehicle.

Preferably, the vehicle comprises two openings on opposing sides of the vehicle.

Preferably, the vehicle is adapted to allow water to drain from the top of the vehicle to the ground without being allowed to enter the opening.

According to a second aspect of the invention, there is provided an openable panel assembly for use in a vehicle, the openable panel assembly comprising:
a ring-shaped frame having first and second inset closing surfaces;
a first panel pivotally connected to a first edge of the frame and operable to close against the first closing surface;
a second panel pivotally connected to a second edge of the frame, the second edge being an opposite edge to the first edge, and operable to close against the second closing surface.

Preferably, the panel assembly comprises sealing means mounted on the first and second closing surfaces such that, when in the closed configuration, the first and/or second panels sealingly close against the frame.

According to a third aspect of the invention, there is provided an openable panel assembly for use in a vehicle, the openable panel assembly comprising a panel connected to the vehicle body via a hinge and operable to pivot to an open configuration in which the panel angles down towards the vehicle body, wherein the assembly comprises a drainage channel along the upper edge of the hinge configured to channel water off the panel and off the side of the hinge.

According to a fourth aspect of the invention, there is provided a vehicle comprising:
rolling means;
a body; and
a chassis system comprising:
   a frame configured to support a body; and
   a suspension system comprising one or more double-acting piston-cylinder assemblies operatively supporting the chassis system on the rolling means, the suspension system configured to selectively vary the height of the frame relative to the rolling means between a ride position and a lowered position,
wherein each of said piston-cylinder assemblies comprises a piston selectively adjustable within a cylinder between a first position corresponding to the ride position and a second position corresponding to the lowered position, and
wherein, when the piston is in the second position, a biasing means within the cylinder applies a biasing force on the piston towards the first position, the biasing force being sufficient to support the frame in an emergency position higher than the lowered position in the absence of hydraulic pressure in the cylinder.

Preferably, the suspension system is also configured to selectively vary the height of the frame between the ride position and a raised position.

Preferably, the piston of each piston-cylinder assembly is also selectively adjustable within the cylinder between the first position and a third position, the third position corresponding to the raised position of the frame.

Preferably, the piston is retracted in the second position, and extended in the third position.

Preferably, the rolling means comprises one or more pairs of wheels, each pair comprising one wheel on either side of the vehicle. In some embodiments the rolling means comprises two or more pairs of wheels.

Preferably, each piston-cylinder assembly is configured to vary the height of a single wheel of the one or more wheels relative to the frame.

Preferably, the suspension system comprises one or more pivoting suspension arms on which the wheels are mounted, and each piston-cylinder assembly acts on one of the pivoting suspension arms. Preferably, each pivoting suspension arm is of a bell-crank design.

Preferably, the pivoting suspension arm is mounted to the frame on both sides of the suspension arm.

Preferably, the suspension system is a hydropneumatic suspension system.

Preferably, the biasing means comprises at least one compression spring.

Preferably, in the absence of a force on the at least one compression spring, the at least one compression spring extends only partially along the length of the cylinder.

Preferably, the biasing means comprises at least one helical spring. More preferably, the biasing means comprises an outer helical spring and an inner helical spring within the outer helical spring, the outer and inner helical springs having opposed helix directions.

In some embodiments, the biasing means comprises at least one polymer spring. Preferably, the biasing means is a polyurethane spring.

Preferably, the chassis system comprises a frame comprising a pair of outer longitudinal members defining the outer sides of the chassis system and, when the frame is in the ride position, the outer longitudinal members are positioned on the outside of and adjacent to the wheels.

Preferably, when the frame is in the raised position, the outer longitudinal members are at a height above the top of the wheels.

In some embodiments, the outer longitudinal members prevent the wheels from being removed from the wheel mounts when the frame is in the ride position but, when the frame is in the raised position, the wheels can be removed from the wheel mounts.

In some embodiments, the vehicle comprises a body supported on the chassis system, the body having sides, an interior and an opening on at least one of the sides, the opening being coverable by at least one panel able to pivot between open and closed positions.

Preferably, the opening is coverable by an upper panel and a lower panel, the upper panel able to pivot at its upper edge, the lower panel able to pivot at its lower edge.

In some embodiments, the vehicle is a trailer. The vehicle may comprise a draw-bar configured to hitch to a towing vehicle.

According to a fifth embodiment of the invention, there is provided a chassis system for a vehicle, the chassis system comprising:
a frame configured to support a body of the vehicle, the frame comprising a pair of outer longitudinal members defining the outer lateral sides of the chassis system;
a plurality of wheel mounts; and
one or more suspension systems connected between each of the plurality of wheel mounts and the frame,
wherein each wheel mount is configured to receive a wheel such that the chassis system is supported on at least one pair of the wheels,
wherein the frame is configured such that each pair of wheels comprises one wheel on each lateral side of the vehicle, the outer longitudinal members positioned on the outside of and adjacent to the wheels when the frame is in a ride position, and
wherein the one or more suspension systems are configured to selectively vary the height of the frame between a ride position and a raised position in which the outer longitudinal members are at a height above the top of the wheels.

In some embodiments, when the frame is in the ride position, the outer longitudinal members prevent the wheels from being removed from the wheel mounts and, when the frame in the raised position, the wheels are able to be removed from the wheel mounts.

Preferably, the chassis system is configured to enable to the suspension system to selectively vary the height of the frame between the ride position and a lowered position.

Preferably, each outer longitudinal member is positioned adjacent a corresponding inner longitudinal member of the frame, and each wheel is positioned between one of the outer longitudinal members and the corresponding inner longitudinal member.

Preferably, the frame comprises suspension arm mounting points and the suspension system comprises pivoting suspension arms pivotally mounted to the suspension arm mounting points.

Preferably, the frame comprises a pair of suspension arm mounting points for each pivoting suspension arm.

Preferably, each pair of suspension arm mounting points comprises a first suspension arm mounting point on one of the outer longitudinal members, and a second suspension arm mounting point on the respective corresponding inner longitudinal member, such that each pivoting suspension arm is mounted on the frame at two of the suspension arm mounting points.

Preferably, the frame comprises a piston-cylinder mounting point associated with each pivoting suspension arm and the suspension system comprises a piston-cylinder assembly mounted in connection between each of the pivoting suspension arms and the respective piston-cylinder mounting points.

Preferably, each piston-cylinder mounting point is spaced from the respective suspension arm mounting point to allow the piston-cylinder assemblies to lift the frame into the raised position and lower the frame into the lowered position.

Preferably, each piston-cylinder mounting point is on one of the inner longitudinal members.

Preferably, the frame comprises wheel arches connected to the frame.

Preferably, the wheel arches have sufficient clearance above the frame that the frame can be lowered substantially to ground level.

Preferably, each wheel arch is connected to one of the outer longitudinal members, one of the inner longitudinal members, and two cross members.

Preferably, the frame comprises a containment region bounded by the inner longitudinal members and cross members.

Preferably, the lateral midpoint of the containment region is substantially aligned with the lateral midpoint of the frame.

Preferably, the containment region is aligned with the wheels along the length of the vehicle.

In some embodiments, the vehicle is a trailer. The vehicle may comprise a draw-bar configured to hitch to a towing vehicle.

In some embodiments, the body comprises lateral sides corresponding to the lateral sides of the frame, an interior and an opening on at least one of the lateral sides of the body, the opening being coverable by at least one panel able to pivot between open and closed positions, the panel being positioned laterally on the outside of the at least one wheel on the respective lateral side of the frame in the closed position, when the body is supported on the frame.

Preferably, the opening is coverable by an upper panel and a lower panel able to pivot between open and closed positions, the upper panel able to pivot at its upper edge, the lower panel able to pivot at its lower edge, the upper and lower panels being positioned laterally on the outside of the at least one wheel on the respective lateral side of the frame in the closed position.

Preferably, the vehicle is a trailer and the frame comprises a front longitudinal member configured to support a drawbar of the trailer.

Preferably, the front longitudinal member is configured to support the drawbar inside the front longitudinal member.

Preferably, the front longitudinal member is configured to telescopically receive the drawbar so that the drawbar is able to be moved between an extended position in which the drawbar can be used to tow the trailer, and a retracted position in which the drawbar can be stored within the frame of the trailer.

According to a sixth embodiment of the invention, there is provided a fluid containment device, for use on a vehicle, the fluid containment device comprising:
a first bladder for containing fluid, the first bladder having a fluid inlet and a fluid outlet;
a second bladder for containing fluid, the second bladder having a fluid inlet and a fluid outlet;
a separation means positioned between the first and second bladders; and
a biasing means configured to act on the separation means,
wherein at least a part of the second bladder is positioned on top of the first bladder,
wherein the separation means is biased by the biasing means towards the first bladder to induce a positive pressure at the outlet of the first bladder, and
wherein the biasing means provides additional bias over a weight of the second bladder and the fluid contained within the second bladder on the separation means.

In some embodiments, the fluid inlet and fluid outlet of the first bladder member are provided through a single fluid passage. In some embodiments, the fluid inlet and fluid outlet of the second bladder member are provided by a single fluid passage.

Preferably, the separation means comprises a plate.

Preferably, the separation means comprises a frame, and the biasing means acts on the frame.

Preferably, the biasing means comprises one or more biasing assemblies, each biasing assembly comprising a spring anchored to an anchor point.

Preferably, each biasing assembly comprises a cable connected between the spring and the separation means.

Preferably, each cable runs over a roller mounted on the fluid containment device so that each cable exerts a substantially downwards force on the separation means and each spring exerts a force on the respective cable in another direction.

Preferably, each spring acts substantially horizontally, or at an oblique angle to the vertical axis, on the respective cable.

Preferably, each roller is mounted proximate the first bladder.

Preferably, the frame comprises four corners, and the biasing means comprises four biasing assemblies, arranged so that each biasing assembly acts on a corner of the frame.

Preferably, the fluid containment device comprises a bias-release means for releasing the bias on the separation means.

Preferably, the fluid containment device is configured to fit within a containment region of a frame of a vehicle chassis system.

Preferably, the fluid containment device is configured to dispense fresh water from the first bladder, and receive grey water in the second bladder.

Further aspects of the invention, which should be considered in all its novel aspects, will become apparent to those skilled in the art upon reading of the following description which provides at least one example of a practical application of the invention.

### BRIEF DESCRIPTION OF THE DRAWINGS

One or more embodiments of the invention will be described below by way of example only, and without intending to be limiting, with reference to the following drawings, in which:

FIG. 1 is a perspective view illustration of a trailer according to an embodiment of the invention in an open configuration;

FIG. 2 is a perspective view illustration of a trailer according to an embodiment of the invention in an open configuration;

FIG. 3 is a perspective view illustration of the trailer shown in FIG. 2 in a partly closed configuration;

FIG. 4 is a perspective view illustration of the trailer shown in FIG. 2 in a partly closed configuration;

FIG. 5 is a perspective view illustration of the trailer shown in FIG. 2 in a partly closed configuration;

FIG. 6 is a perspective view illustration of the trailer shown in FIG. 2 in a fully closed configuration;

FIG. 7 is a perspective view illustration of an opening of the trailer as shown in FIG. 2 in an open configuration;

FIG. 8 is a perspective view illustration of the opening shown in FIG. 7 in a partly closed configuration;

FIG. 9 is a perspective view illustration of the opening shown in FIG. 7 in a partly closed configuration;

FIG. 10 is a perspective view illustration of the opening shown in FIG. 7 in a partly closed configuration;

FIG. 11 is a perspective view illustration of the opening shown in FIG. 7 in a fully closed configuration;

FIG. 12 is a perspective view illustration of a trailer according to another embodiment of the invention;

FIGS. 13a-c are side view illustrations of the trailer of FIG. 12 in a ride, a lowered and a raised position respectively;

FIGS. 14a-c are side view illustrations of the suspension system of the trailer of FIG. 12 in the ride, lowered and raised positions respectively;

FIG. 15 is a perspective view illustration of the frame and suspension system of the trailer of FIG. 12 in a raised position;

FIG. 16 is a perspective view illustration of a suspension arm of the trailer of FIG. 12;

FIG. 17 is a partially sectioned plan view illustration of the frame of the trailer of FIG. 12;

FIG. 18 is a partially exploded perspective view illustration of the frame, suspension system and drawbar of the trailer of FIG. 12;

FIG. 19a-c are side cross section view illustrations of the piston-cylinder assembly of the trailer of FIG. 12;

FIG. 20a-c are side cross section view illustrations of a piston-cylinder assembly according to another embodiment of the invention;

FIG. 21 is a perspective view schematic of a fluid containment device according to one embodiment of the invention;

FIG. 22 is an exploded view schematic of the fluid containment device of FIG. 21;

FIG. 23a is a cross section side view schematic of the fluid containment device of FIG. 21 when the first bladder is full; and

FIG. 23b is a cross section side view schematic of the fluid containment device of FIG. 21 when the second bladder is full.

### DETAILED DESCRIPTION OF PREFERRED EMBODIMENTS OF THE INVENTION

### Vehicle Openings and Interior

Preferred embodiments of the invention comprise a trailer with an interior which may be empty so that the whole of the trailer's contents can be removed, or having one or more features fixed to the walls, floor or roof of the interior. The trailer is longer in the towing direction, has a side-hinged door in the rear wall, and on each side wall there is an upper and lower panel able to pivot between an open and closed position. The upper panel pivots about its top edge, which is near the top of the trailer, and the lower panel pivots about its lower edge near the lower surface or floor of the interior. The panels both pivot outwardly to create an opening in the side of the trailer, the upper panel forming a roof extending out over the lower panel, which forms a platform substantially at the same level as the lower surface of the interior.

Around the perimeter of the opening of the trailer is a ringframe comprising an inner sealing surface and an outer sealing surface. Each sealing surface has a sealing means, for example a rubber seal. The lower panel closes against the inner sealing surface to create a first seal around the perimeter of the opening, and the outer panel closes against the outer sealing surface to create a second seal around the perimeter of the opening. The two seals created in the closed configuration advantageously prevent transfer of water into the interior from the exterior of the trailer.

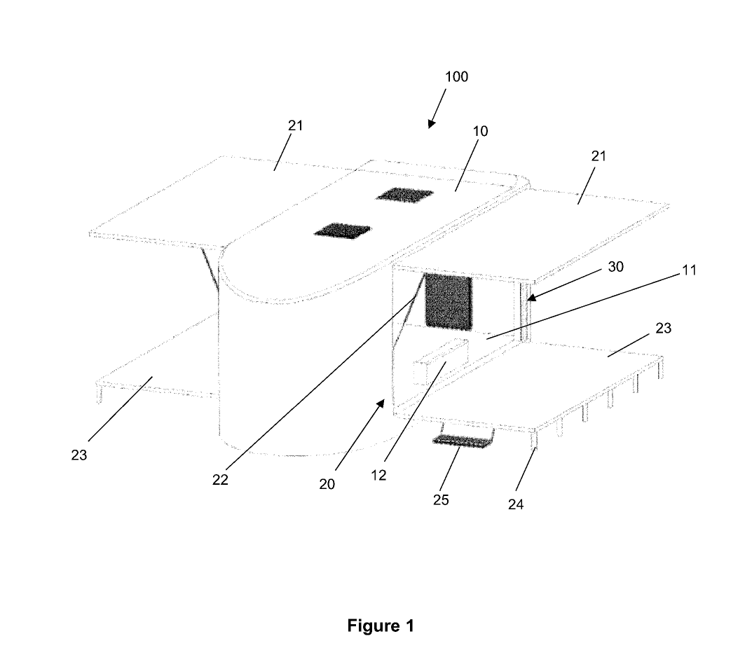

FIG. 1 shows a perspective view of trailer 100 according to an embodiment of the invention. The trailer comprises rolling means, such as wheels, a chassis and a body 10 mounted on the chassis. Body 10 defines the general shape of trailer 100, and is longer in the direction in which it is to be towed. In this embodiment the front of body 10 is rounded such that it is less affected by aerodynamic forces while in motion, and comprises other various features such as rounded/bevelled edges and an upwardly flaring portion at the back end. No drawbar for the trailer is shown, but in practice a drawbar or other towing means may extend from the front portion of the trailer.

The chassis of the trailer 10 may comprise, or be connected to, one or more suspension systems on which the wheels are mounted. The chassis of vehicles according to embodiments of the invention may be considered a chassis systems and may comprise, for example, a frame on which a body of the vehicle is supported, and a suspension system connecting the frame to wheels of the vehicle.

Body 10 has at least one opening 20 in the side walls. Upper panels 21 are hinged at the upper edges of the openings 20, and lower panels 23 are hinged at the lower edges of the openings 20. FIG. 1 shows trailer 100 with both of its openings 20 in an open configuration, the upper panels 21 and lower panels 23 being pivoted such that they extend away from the body 10 allowing interior 11 to be open to the surroundings.

Upper panel 21, when in the open configuration, provides a covering to prevent the elements or objects from falling alongside the opening 20 and over the platform formed by lower panel 23, described in more detail below. In the open configuration, upper panel 21 may be oriented at an angle to the horizontal such that rain water drains off it.

Struts 22 support upper panels 21 in the open position, positioned on either side thereof. Struts 22 are in some embodiments gas struts that allow the upper panel 21 to be easily moved between its closed and open configurations. The struts 22 may in other embodiments be any fixed or removable means of supporting upper panel 21 in the open position and, in some embodiments, as it moves between open and closed positions, and vice versa.

Lower panel 23, when in the open configuration, provides a platform separated from the ground. As such, the usable floor area of the trailer is increased from the footprint area of body 10 to the footprint area plus the areas of the one or more lower panels 23. This usable area may be used for any number of reasons that will be apparent to the skilled addressee. Advantageously, in some embodiments, lower panel 23 is substantially at the same height as the lower surface or floor of the interior 11 of trailer 100. This provides for a large continuous usable surface so that people can walk between the tops of lower panels 23 and the floor of the trailer body 10 without tripping or stepping up or down. However, in alternative embodiments, the floor may be discontinuous by virtue of the lower panels being at a different height from the trailer body floor.

In its open position, legs 24 extend vertically downwards from the outermost edge of lower panel 23 to support lower panel 23 in a substantially level configuration. The legs of the trailer's lower panel may be completely removable or they may be hinged such that they are able to fold into the lower panel. Their height may be adjustable, which is advantageous for when the trailer is required to be opened on uneven ground, or if the user would like the lower panel to have a slope, which may be useful for unloading and loading equipment.

Step 25 is located at the front end of lower panel 23 to facilitate easy access to the top surface of lower panel 23 and the interior 11.

In this embodiment, both upper panels 21 and lower panels 22 are substantially the same size as opening 20. This is advantageous for maximising the size of the platform and cover provided by the panels alongside body 10. However other embodiments provide for panels of different sizes. For example, in one embodiment the areas of the upper and lower panels may total to an area equal to the size of the opening such that, in the closed configuration, the outer edges of the upper and lower panels abut.

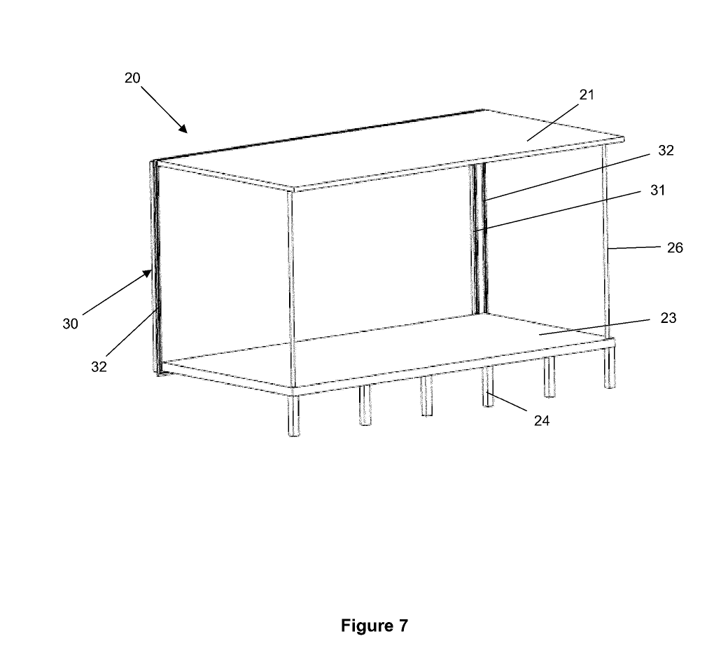

Surrounding opening 20 is ringframe 30. Ringframe 30 is described in detail with reference to FIGS. 7-11.

Wheel arch 12 defines the top of a wheel well which houses the wheels of the trailer and protrudes upwards into the interior from the floor. This design advantageously allows the floor to be lower, providing the interior with greater volume, and allowing the platform formed by lower panels 23 to be closer to the ground, allowing for easier access and more space between the upper panel 21 and lower panel 23 in their open configurations. By increasing the available vertical space for the trader to use, the interior of the trailer is also more visible from the outside. Wheel arch 12 may take any shape, and does not necessarily need to be arched. For example, wheel arch 12 is box-shaped. The wheel arch 12 may double, for example, as a bench, counter or other type of fixture.

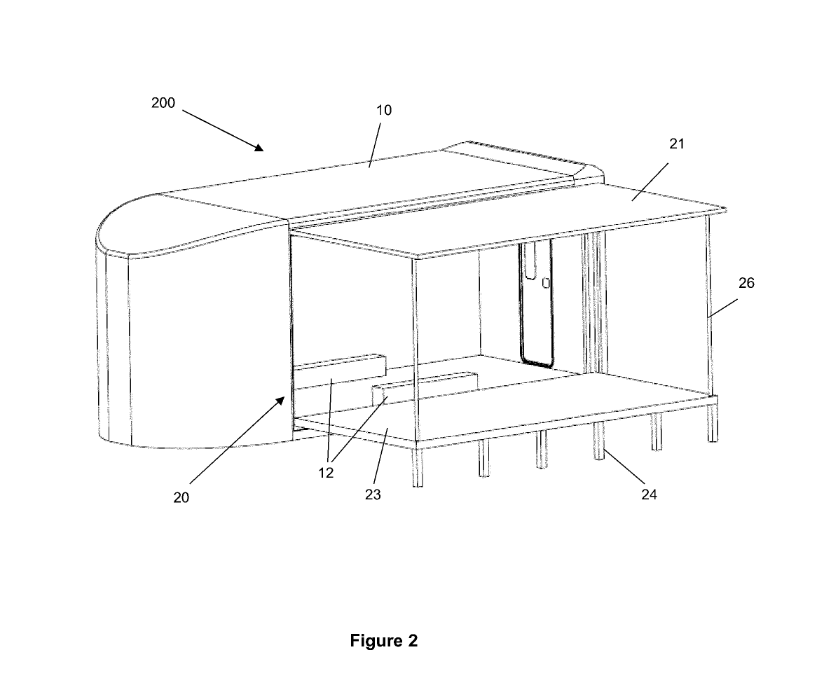

FIGS. 2-6 show perspective views of trailer 200 in various configurations according to an embodiment of the invention, and in particular show further detail of the opening 20 and related features. The same reference numerals are used for FIGS. 2-6 as were used for trailer 100 in FIG. 1 to describe like features, however there are various differences, for example body 10 of trailer 200 comprises a slightly different shape, and has no roof hatches. Furthermore, trailer 200 comprises outer struts 26 rather than the gas struts 22 of trailer 100, and also only comprises one opening 20.

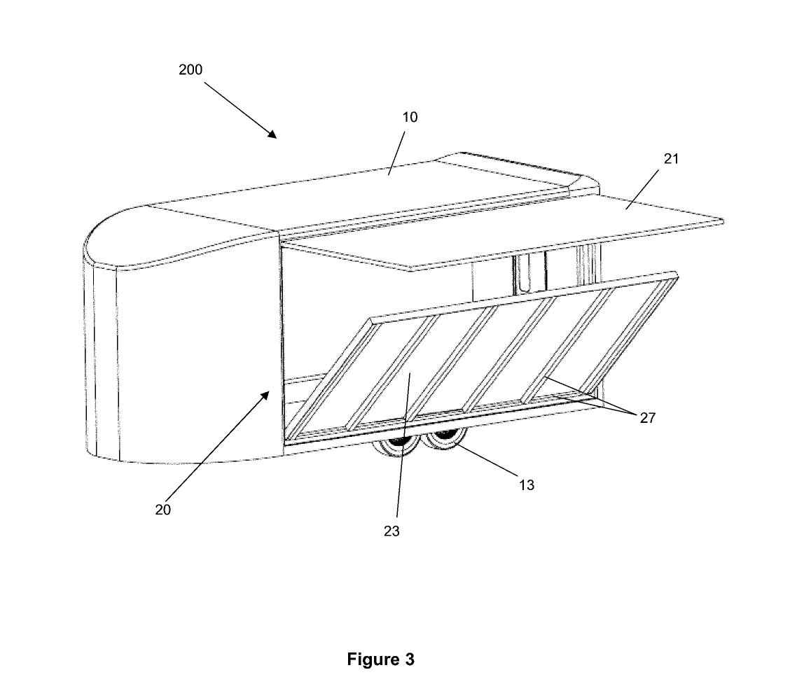

FIG. 3 shows trailer 200 in an intermediate configuration between open and closed. Struts 26 have been removed and can be stowed, and lower panel 23 is in the process of being raised. As shown in FIG. 3 the lower panel 23 pivots about the lower edge of opening 20, moving towards an orientation substantially parallel to the sides of body 10. Wheels 13 are also visible, corresponding to the location of wheel arch 12. In other embodiments there may be a different number of wheels.

Structural members 27 of lower panel 23 are visible in FIG. 3, and may comprise box section steel or any other material or arrangement of members able to provide the lower panel with sufficient rigidity and strength to be used as a platform in the open position. In some embodiments the structural members of the lower panel may contribute to the strength of the trailer itself when in the closed configuration.

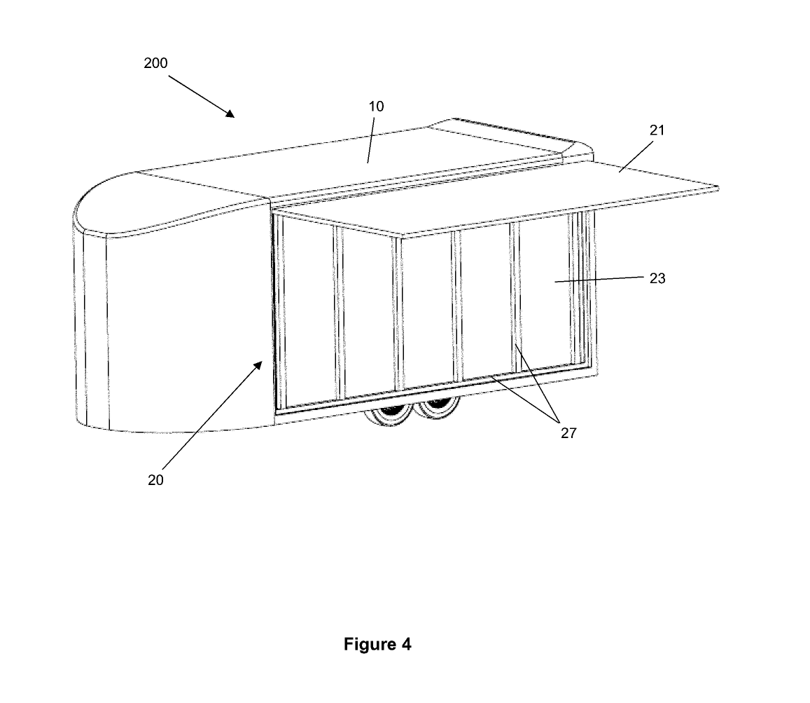

FIG. 4 shows trailer 200 with the lower panel 23 in its closed configuration, in which it is substantially parallel to the sides of body 10, and recessed into the side of body 10. It is advantageous for lower panel 23 to be recessed into the side of body 10 to allow space for upper panel 21 to fill when closed, allowing the trailer in its closed position to have substantially flat sides without projections, or at least minimise any projection from the side to the thickness of upper panel 21. Lower panel 23 may be locked or otherwise secured in place.

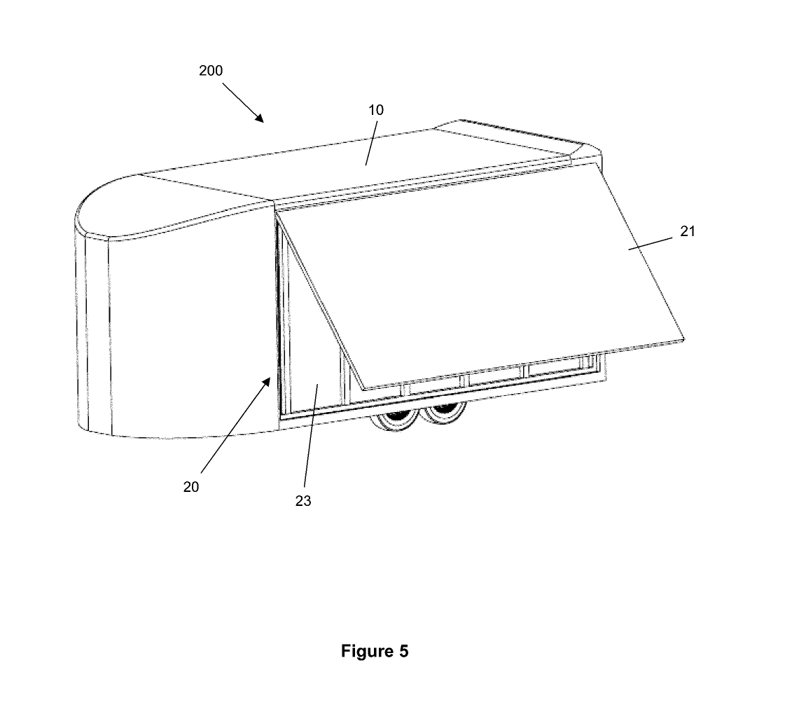

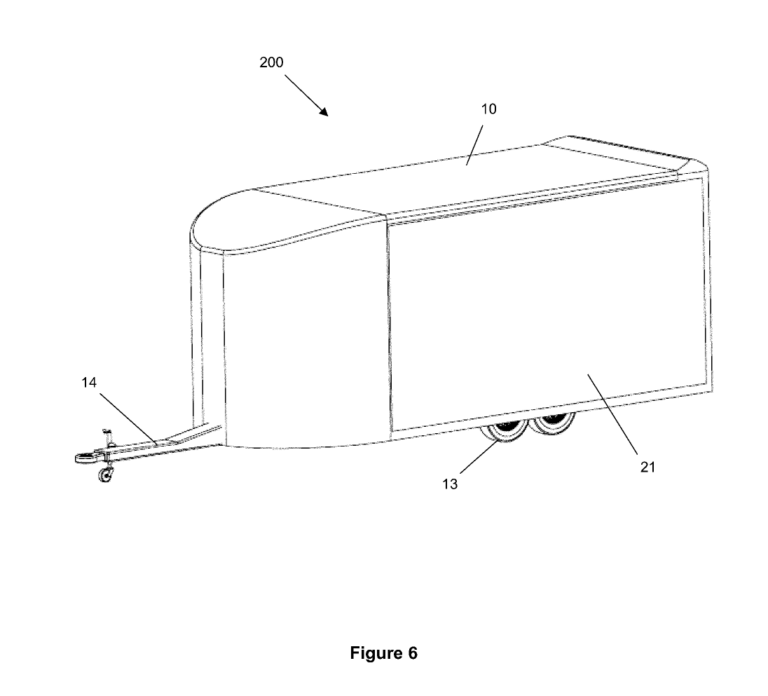

FIG. 5 shows trailer 200 with the upper panel 21 lowered partway down towards a closed configuration. Upper panel 21 pivots downwards about its upper edge.

FIG. 6 shows trailer 200 in its closed configuration. Upper panel 21 is substantially parallel with the sides of body 10, and in this embodiment is substantially flush with the sides of body 10, an advantageous feature allowing the side of body 10 to be substantially flat or continuous in the closed configuration. The outer surface of upper panel 21 may be used to display branding, logos, advertising and the like. Unlike lower panel 23, upper panel 21 may not be required to withstand high loads and therefore may not need to be reinforced, enabling a smooth outer surface finish.

In other embodiments, the upper panel may close first, with the lower panel closing over the top of it. However the embodiment shown in which the upper panel closes on top of the lower panel may be advantageous for reducing water egress into the trailer.

Drawbar 14, an exemplary drawbar with which the trailer can be towed, is also shown.

While specific details are not shown in the Figures, the hinges at the upper and lower edges of opening 20 which connect upper panel 21 and lower panel 23, respectively to the body 10, are recessed and/or hidden. This advantageously allows for the lower panel 23 to be recessed within the opening 20 of body 10, and for upper panel 21 to be substantially flush or close to flush with the outer surface of body 10 in its closed position. This allows for efficient sealing of the lower and upper panels to the body of the trailer when in the closed configuration to prevent transfer of water and potentially air from the exterior to the interior. Furthermore, it may make the trailer aesthetically pleasing when closed, and prevents unnecessary projections from the sides of the trailer, allowing the body 10 to be as wide as allowable, maximising the interior volume and avoiding hazardous projections from the sides of body 10.

While not shown in the Figures, the upper and lower panels may each be provided with any means to lock them in place for safety and security.

FIGS. 7-11 show opening 20 of a trailer according to an embodiment of the invention. The rest of the trailer is omitted in order to describe the features related to ringframe 30 and the advantageous results provided. The ringframe may be mounted on the chassis of the trailer and connected to other parts of the trailer frame.

FIG. 7 shows opening 20 in an open configuration. Upper panel 21 and lower panel 23 are extended outwardly such that they are substantially parallel to the ground and perpendicular to the side of body 10 to provide an upper covering and lower platform, respectively. Outer struts 26 are positioned at the far ends of upper panel 21 and lower panel 23 to support upper panel 21. Legs 24 are also shown supporting lower panel 23 substantially parallel to the ground (ground not shown).

Also visible in FIG. 7 is ringframe 30, which defines the boundary of the opening 20 in the side of body 10, and provides surfaces for upper panel 21 and lower panel 23 to seal with when in their closed configurations.

Ringframe 30 has two sealing surfaces, inner sealing surface 31 and outer sealing surface 32, each comprising a rubber seal or other seal able to ensure the gaps between ringframe 30 and upper panel 21 and lower panel 23 are substantially airtight and watertight when in a closed configuration. In the case of a rubber seal, the seal may be installed in a recess within the sealing surface and project outwards. When the panel closes it may compress and deform the seal to ensure a tight fit between the seal and the panel, substantially preventing water and air from leaking or flowing into the interior.

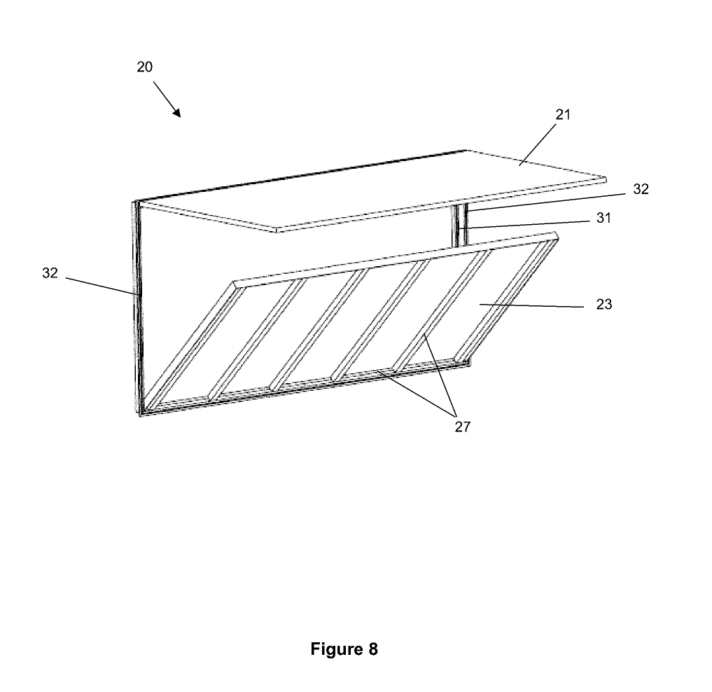

FIG. 8 shows opening 20 in an intermediate configuration between open and closed. Legs 24 and struts 26 are removed, and lower panel 23 is raised up, pivoted about the hinges at its lower edge where it meets ringframe 30. This configuration shows that lower edge of lower panel 23 is located partly within ringframe 30, and completely within outer sealing surface 32. FIG. 8 shows that as lower panel 23 is moved towards its closed configuration, it moves towards inner sealing surface 31.

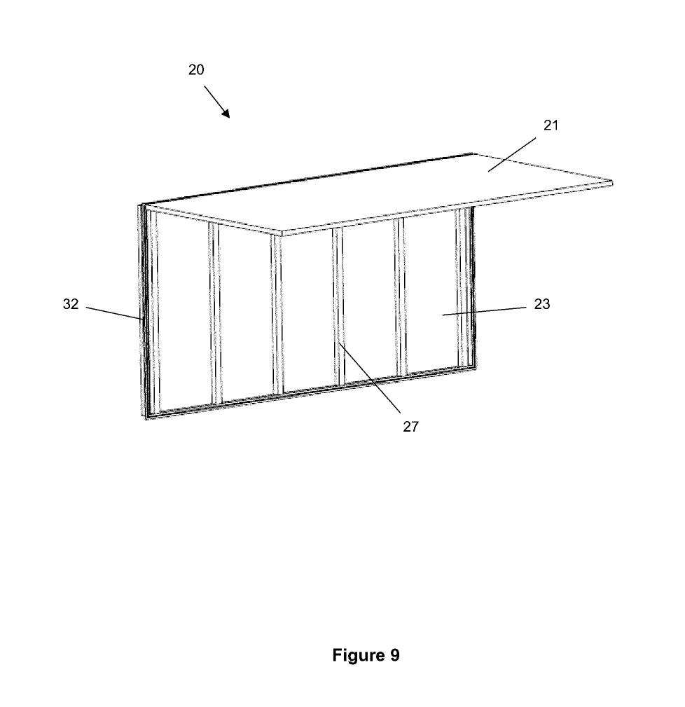

FIG. 9 shows opening 20 in an intermediate configuration with lower panel 23 in its closed configuration. Lower panel 23 is in contact with inner sealing surface 31 (shown in FIG. 8 but not visible in FIG. 9) such that a seal is formed between inner sealing surface 31 of ringframe 30 and lower panel 23 to prevent water or air transfer between the interior and exterior. Lower panel 23 completely fits within the outer sealing surface 32, and does not project outwardly past outer sealing surface 32 to allow upper panel 21 to be pivoted downwards to its closed configuration and meet outer sealing surface 32 and form a seal.

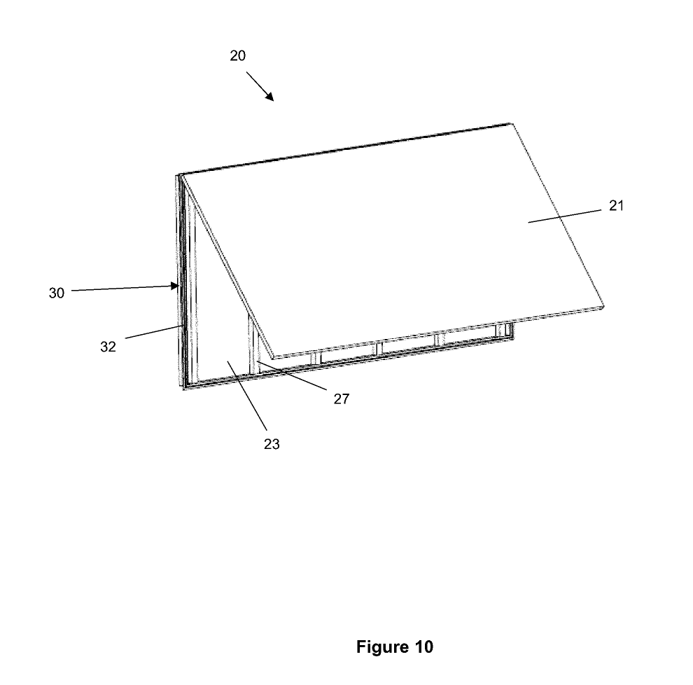

FIG. 10 shows opening 20 in an intermediate configuration with upper panel 21 being brought into its closed configuration, pivoting at its upper edge.

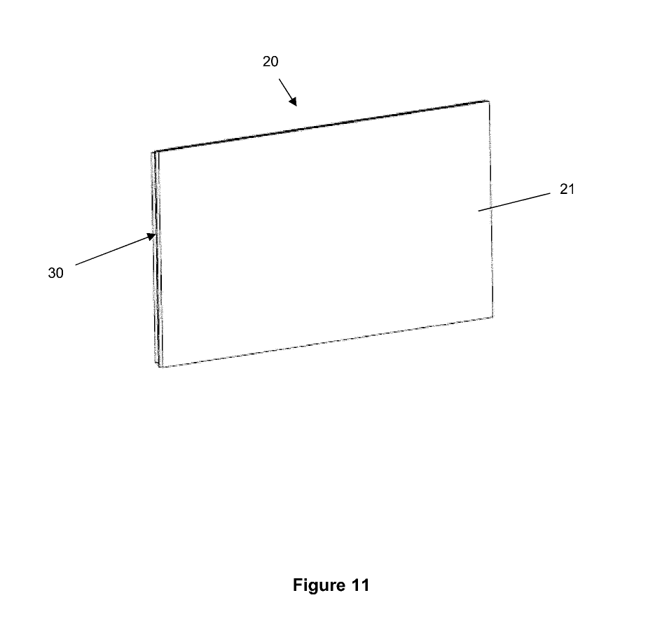

FIG. 11 shows opening 20 in the closed configuration. Upper panel 21 is in contact with outer sealing surface 32 (shown in FIG. 10 but not visible in FIG. 11) such that a seal is formed between outer sealing surface 32 of ringframe 30 and upper panel 21 to prevent water or air transfer between the interior and exterior.

### Drainage

Preferred embodiments of the invention comprise a drainage system designed to manage water that may collect on top of the trailer. Water collecting on top of the trailer may land or form directly on the roof or on an upper panel in its open configuration. Preferably there is drainage in the form of a channel, gutter or similar on or near the edge of the trailer's roof between the roof and the hinged edge of the upper panel such that water can drain into the channel or gutter from the roof and/or the upper panel. Preferably, the channel or gutter is adapted to allow the water to flow to a desired location on the roof, for example the back, and into a drainpipe, spout or other means to transfer the water from the roof to the ground without interfering with people or objects on or around the trailer.

In some embodiments, the drainage channel may be formed on top of, or by, the upper surface of the hinge connecting the upper panel to the ringframe.

### Adjustable Height

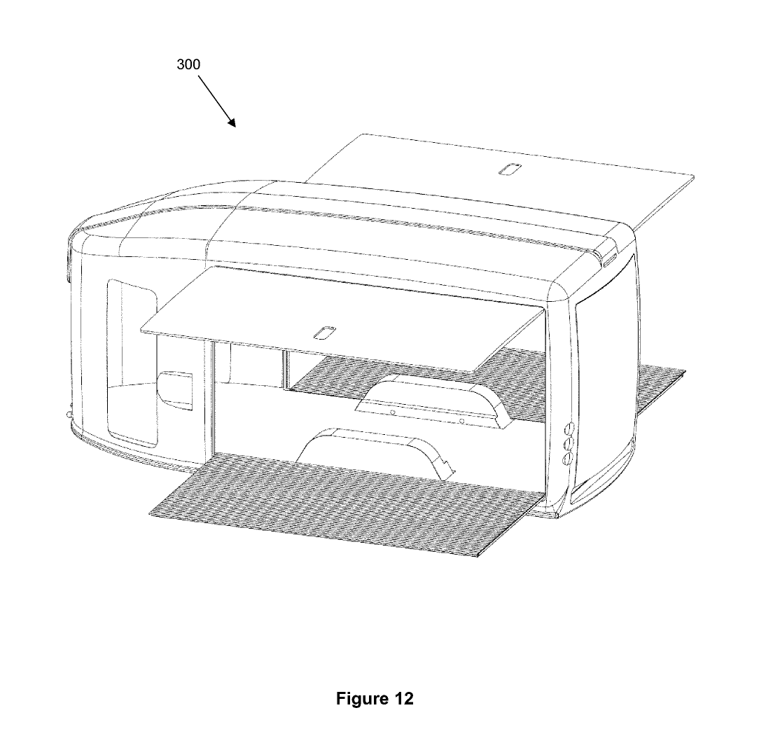

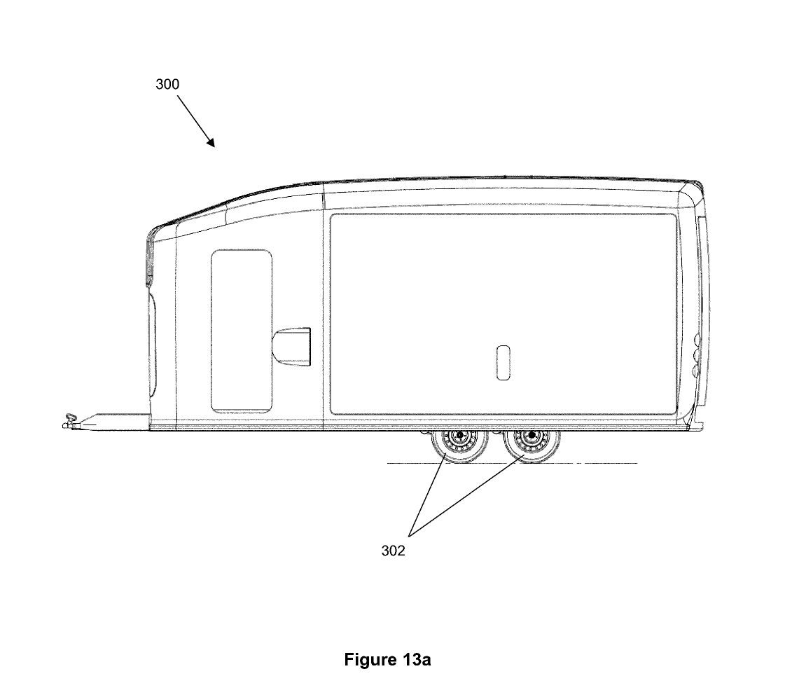

FIG. 12 is an illustration of a trailer 300 according to another embodiment of the invention. Trailer 300 has many of the features of trailers 100 and 200, such as the openable sides and the large substantially continuous floor space. It should be understood that any or all of the features described with reference to trailers 100 and 200 may be applied to trailer 300. Additionally, any or all of the features which will now be described with reference to trailer 300 may equally be applied to trailers 100 or 200.

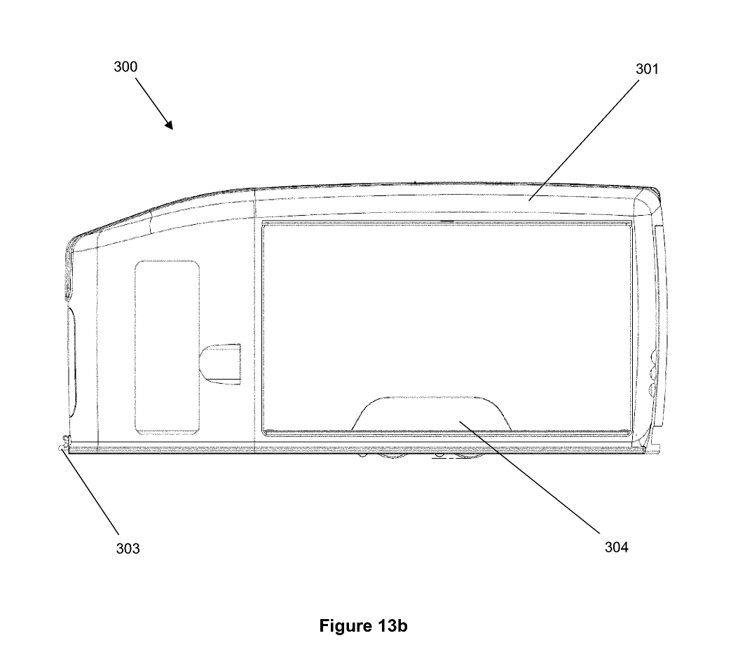

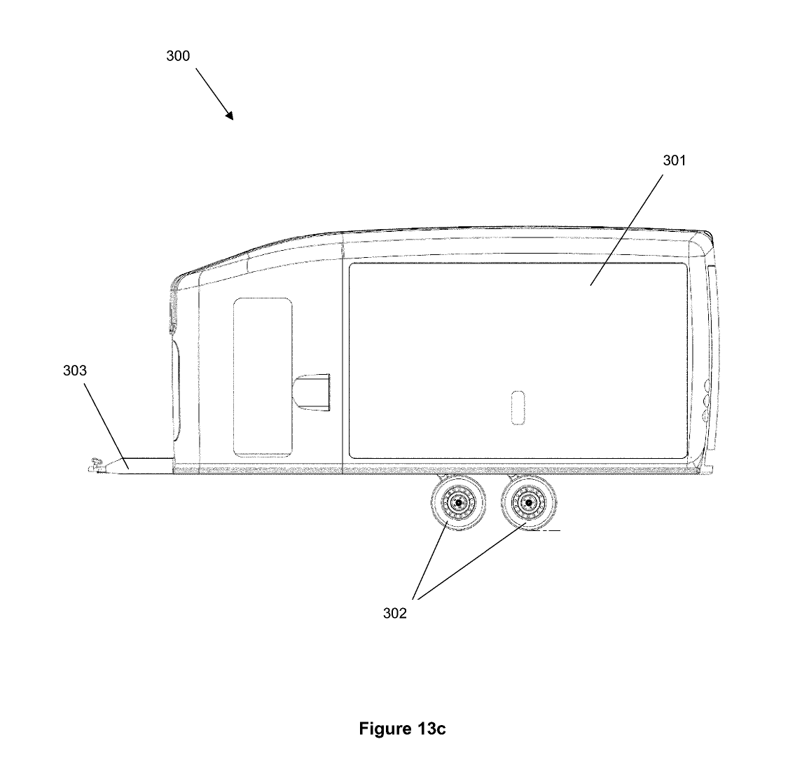

FIGS. 13a-13c show side views of the trailer 300 having a body 301 on a chassis system (not shown), wheels 302 and a drawbar 303. There are two pairs of wheels 302 in this embodiment, each pair comprising a wheel 302 on either side of the trailer, i.e. for each pair of wheels, one of the wheels is on each side of a longitudinal centre line of the trailer. In preferred embodiments of the invention, the wheels are not positioned on the outermost side of the chassis system and/or body of the trailer.

The chassis system of the trailer 300 comprises an adjustable suspension system which is able to be selectively adjusted between a ride position (in which trailer 300 is shown in FIG. 13a), a lowered position (in which trailer 300 is shown in FIG. 13b) and a raised position (in which trailer 300 is shown in FIG. 13c). During travel, i.e. when the trailer 300 is towed behind a vehicle by a drawbar 303, it will be in the ride position in which the body 301 is at an appropriate height relative to the wheels 302 that the trailer 300 has sufficient ground clearance for travel, but a centre of gravity low enough for safe handling.

When the trailer 300 is parked in order to open up the sides and serve as a display trailer or other purposed trailer, or in a situation where people may be entering and exiting the interior, the trailer 300 can be adjusted to the lowered position, in which the body 301 has moved low relative to the wheels 302, and the underside of the trailer 300 is at or nearer ground level than in the ride position. In FIG. 13b, the sides of trailer 300 are opened up, exposing the wheel arch 304, which is sufficiently large that the body 301 and body and a frame of the chassis system (not shown) on which the body 301 is supported can be lowered close to ground level without interference from the wheels 302. As can be seen in FIG. 13b, the drawbar 303 has been retracted, details of which will be described in further detail later.

The design of the body, side panels, chassis system and wheel positioning is such that the wheels are completely, or near completely, obscured from view when the trailer is in the lowered position, which provides for a safe and aesthetically pleasing display trailer. For example, it may enable the lowered sides of the trailer, which may serve as platforms when lowered, to be low enough to the ground to enable people to step easily up onto the platforms. The wheels are also partially obscured in the ride position, as shown in FIG. 13a.

In the event that a tyre of a wheel 302 goes flat, the wheel can be accessed for changing by adjusting the height of the body 301 (and parts of the chassis system described below) relative to the wheels to put the trailer in the raised position shown in FIG. 13c. The wheels are then unobstructed by the body or chassis system and can easily be removed from wheel mounts (which may also be known as wheel hub assemblies) by pulling the wheels straight outwards from the wheel mounts. In some embodiments, the design of the chassis may enable the wheels to be removed in the ride position but with difficulty, and the ability to raise the body clear of the top of the wheels makes removing the wheels easier. In some countries it may be a legal requirement to be able to remove a vehicle's wheels by pulling them straight outwards.

To resume travel, the trailer 300 is then lowered to the ride position of FIG. 13a once again.

### Suspension

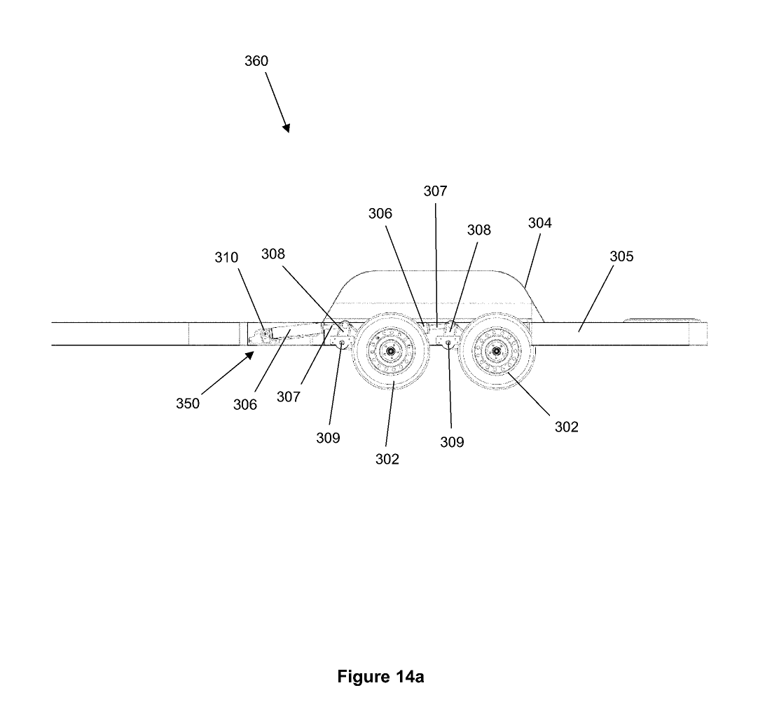

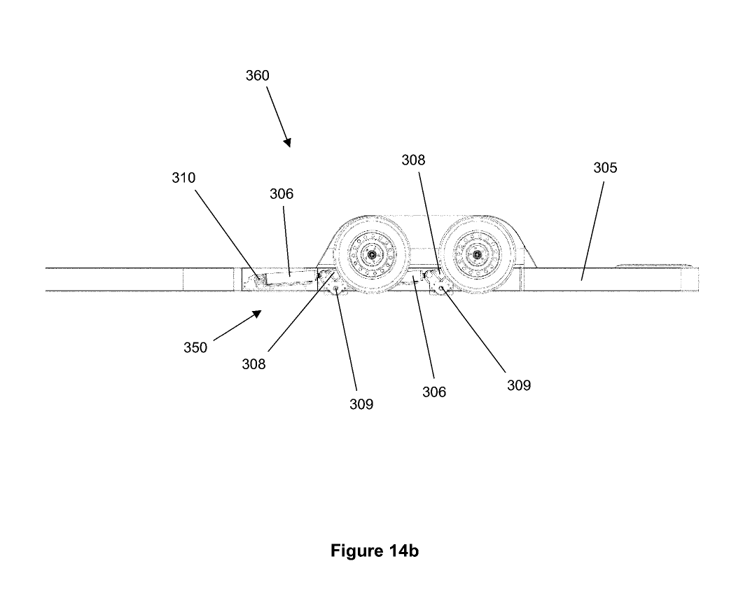

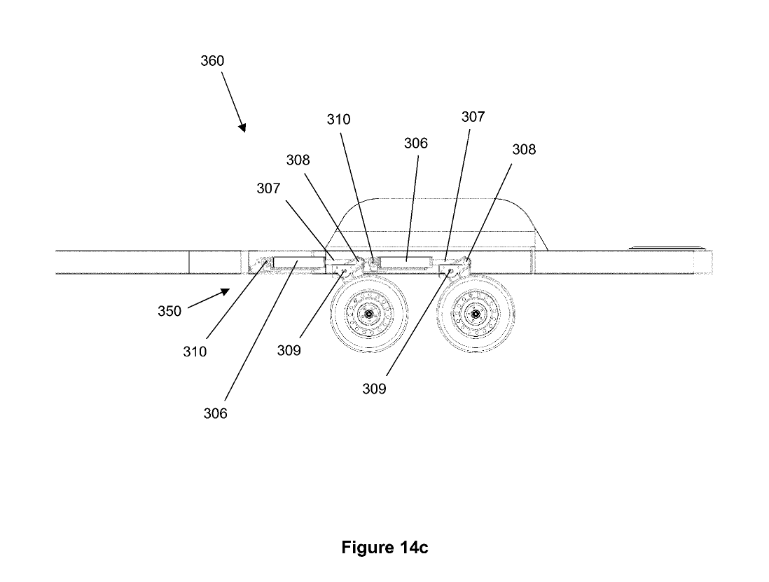

The suspension system design is shown in FIGS. 14a-c, which show side views of the chassis system 360 of the trailer 300 with the body and some parts of the chassis system removed to show the arrangement of a suspension system 350 which supports the chassis system on the wheels more clearly. FIG. 14a shows a frame 305 of the chassis system, on which the body (not shown) of the trailer 300 can be mounted, and its height relative to the wheels 302 in the ride position. FIG. 14b shows the frame 305 in a lowered position, and FIG. 14c shows the frame in a raised position.

The wheels 302 are each rotatably mounted on an end of a pivoting suspension arm 308, which pivots about a suspension arm mounting point 309 provided by a bracket on the frame 305. Each pivoting suspension arm 308 is of a bell-crank style, with the other end connected to a hydraulic piston-cylinder assembly comprising a cylinder 306 and piston 307. The piston 307 is pivotally connected to the pivoting suspension arm 308, and the cylinder is pivotally mounted to a piston-cylinder mounting point 310 provided by a bracket on the frame 305.

In the embodiment shown the suspension arms are of a bell-crank style in that one end is able to be acted on by a force (e.g. by piston 307) in one direction (e.g. horizontal) to provide a resulting movement of the other end in a different direction (e.g. vertical). The bell-crank design of the suspension arms allows the hydraulic cylinders to be positioned within the frame (e.g. alongside members of the frame), and act in a generally horizontal direction, subject to minor pivoting. This allows a body mounted on the chassis system to have more useable space, given the piston-cylinder assemblies occupy vertical space already occupied by the frame. In alternative embodiments, the suspension arms may be of any suitable alternative design including any type of curved or angled member able to convert a force in one direction to movement in another direction or any other such device, such as of a trailing/leading arm style having the wheel mount provided on the same side of a pivot point as the connection with the piston of a hydraulic cylinder.

The piston-cylinder assemblies therefore support the chassis system on the wheels, and as will now be explained, the system is selectively adjustable to vary the height of the frame relative to the wheels between a ride position, a lowered position, and a raised position. In this embodiment, the suspension is hydropneumatic, meaning that the one or more hydraulic circuits which are used to adjust the position of the pistons within the cylinders to raise and lower the frame, are coupled to one or more pneumatic circuits to provide a shock absorption function. The hydraulic cylinders 306 are preferably double acting cylinders coupled to one of more accumulators filled with a gas, such as nitrogen, to allow the pistons 307 to move within the cylinders to accommodate and absorb shocks by allowing the gas to compress/expand to provide spring return, and forcing the hydraulic fluid or gas through valve(s) to provide damping. Hydraulic fluid can be added or removed from the one or more hydraulic circuits fluidly connected to the cylinders by one or more pumps to extend or retract the pistons 307 to cause the frame 305 to be raised or lowered. A control system acts to control the hydraulic system and to thereby control the position of the frame relative to the wheels. The control system may be manually operated. The hydropneumatic system may also be used to achieve a desired ride height with different trailer weights (e.g. for different loadings or fit outs) by adjusting the amount of hydraulic fluid provided to the cylinders as required to achieve the desired ride height.

As shown in FIGS. 14a-c, the extension and retraction of the pistons 307 by the hydraulic cylinders 306 forces the pivoting suspension arms 308 to rotate about suspension arm mounting points 309, thereby adjusting the vertical position of the wheel mounts of the wheels 302 relative to the suspension arm mounting points 309, causing the frame 305 to be raised or lowered accordingly. The pistons are therefore selectively adjustable within their cylinders between a first position corresponding to a ride position of the frame, a second position corresponding to a lowered position of the frame, and a third position corresponding to a raised position of the frame. As will be described later, the pistons may also occupy an emergency position corresponding to a height of the frame higher than the lowered position.

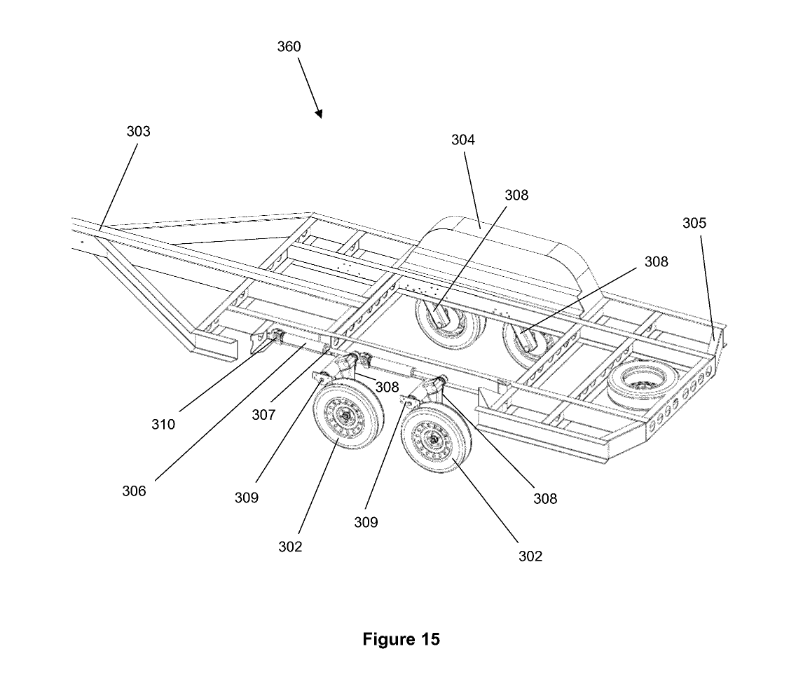

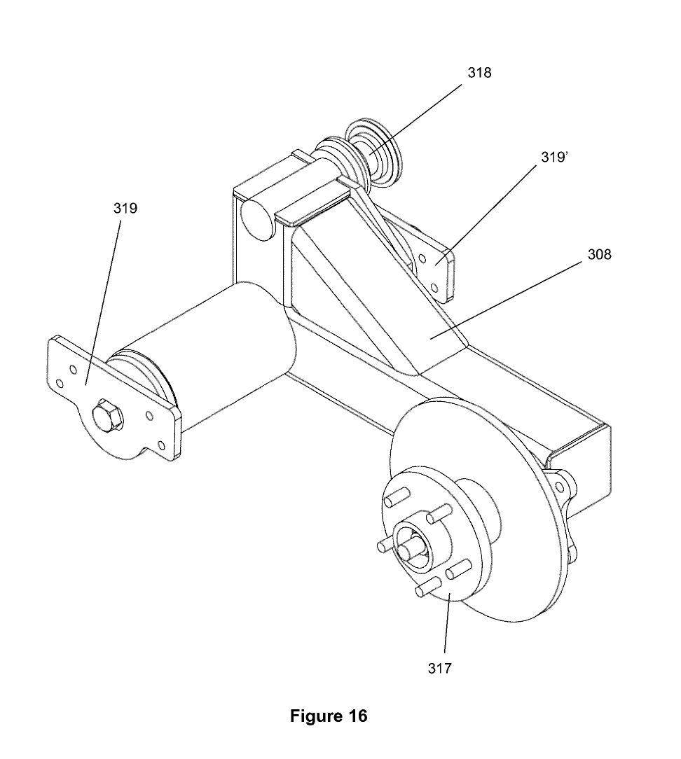

FIG. 15 shows a perspective view illustration of the chassis system 360 with the suspension assemblies and wheels 302 attached to the frame 305, with portions of the frame 305 and one of the wheel arches 304 removed for visibility.

FIG. 16 shows a perspective view illustration of a pivoting suspension arm 308 of the trailer 300. The pivoting suspension arm 308 comprises two mounting brackets 319 and 319′ configured to be attached to mounting points 309 and 309′ on the frame 305, which will be described later. The mounting brackets in this embodiment are configured to be fastened to the frame with fasteners, but in other embodiments pivoting suspension arms may be configured to attach to mounting brackets welded to the frame. At one end of the bell-crank style arm is a wheel mount 317 and at the other end is a piston connection point 318. Force applied on the piston connection point 318 therefore causes movement of the wheel mount 317. In this embodiment, due to the suspension connecting arm 308 pivoting about the axis between brackets 319 and 319′, horizontal action of a piston on the piston connection point 318 adjusts the vertical height between the axis of the wheel mount and the axis of the suspension arm pivot.

### Chassis System

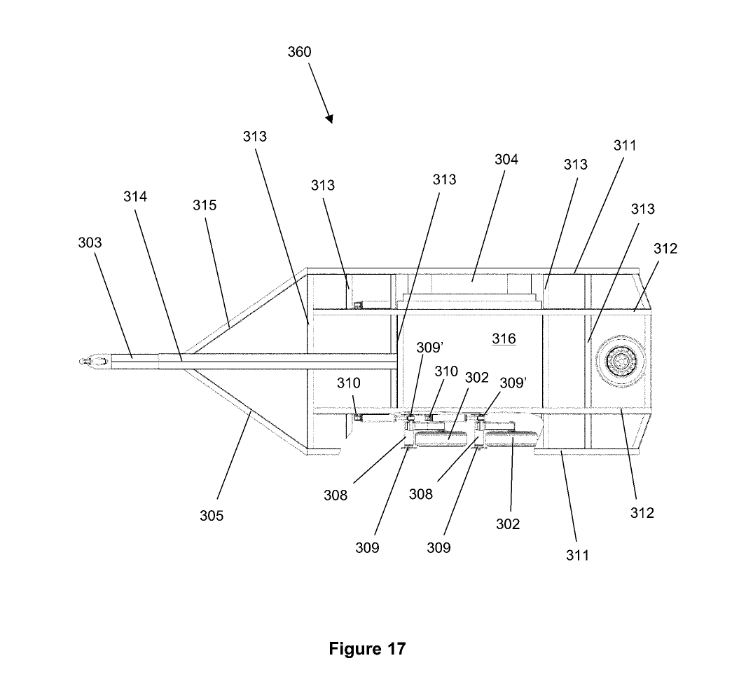

FIG. 17 shows a partially sectioned plan view of the chassis system 360 with suspension assemblies 350 attached to the frame 305 and wheels 302 attached to the wheel mounts. The suspension system 350 connected between each of the wheel mounts and the frame supports the chassis system 360 on the wheels and is also configured to selectively vary the height of the frame 305 between the ride position and the raised position. The wheels 302 are in pairs, with one wheel of each pair being one each lateral side of the vehicle. One of the wheel arches is not shown in FIG. 17 so that one set of wheels and the corresponding suspension system are visible. A portion of an outer longitudinally extending structural member 311 is also not shown for clarity.

The frame 305 is configured to support a body of the vehicle, and comprises a pair of outer longitudinal members 311 defining outer lateral sides of the chassis system 360, inner longitudinal members 312, cross members 313, a forward longitudinal member 314 and nose members 315. The outer longitudinal members 311 are positioned on the outside of and adjacent to the wheels 302 when the frame 305 is in the ride position but above the top of the wheels when the frame is in the raised position. The wheel arches 304 are also connected to the frame and are advantageous in providing further rigidity to the frame 305 by acting as a bracing member between longitudinal and transverse members of the frame. Cross members 313 connect between the paired longitudinal members 311 and 312, between the inner longitudinal members 312, and between the outer longitudinal members 311 and the front longitudinal member 314. Each wheel arch 304 connects to an outer longitudinal member 311, an inner longitudinal member 312, and a cross member 313 at the forward and rear end of the wheel arch. In other embodiments the frame may comprise additional members and/or it may not include all the members shown in FIG. 17.

As can be seen in FIG. 17, each of the outer longitudinal members 311 is parallel to but spaced apart from a corresponding inner longitudinal member 312 on either side of the frame 305. The wheels 302 are all positioned in between an outer longitudinal member 311 and the corresponding inner longitudinal member 312 on wheel mounts. The pivoting suspension arms 308 are advantageously mounted to two suspension arm mounting points 309 and 309′ (a pair), the mounting point 309 being a first suspension arm mounting point on the outer longitudinal member 311 and the mounting point 309′ being a second suspension arm mounting point on the inner longitudinal member 312. This provides sturdy support for the pivoting suspension arm 309 and avoids the moment that would be induced if only a single mounting point was used. The piston-cylinder mounting points 310 are on the inner longitudinal member 312 in this embodiment.

The chassis system therefore provides a frame with outer longitudinal members positioned outside of and beside the wheels. The outer longitudinal members prevent the wheels from being removed from their wheel mounts when the frame is at a ride height by pulling the wheels straight outwards from the wheel mounts and may be positioned sufficiently close to the outer side of the wheels to prevent the wheels being removed at all. Despite this problem, this chassis system design is advantageous as it allows for large panels on the sides of a body to close over the outside of the wheel, and open up to create a wide nearly flat or continuous floor plane, while keeping the wheels covered under wheel arches. The design of the frame and its mounting points allow the frame to be raised conveniently when required, into a raised position in which the outer longitudinal members are raised above the height of the top of the wheels, allowing the wheels to be removed from their wheel mounts by pulling the wheels straight outwards from the wheel mounts.

Another feature of the chassis system is that the frame 305 comprises a containment region 316 formed by a space between the frame members. Specifically, the containment region 316 is bounded by the inner longitudinal members 312 on the lateral sides, and by a cross member 313 on each of the front and rear sides. The containment region 316 is centred generally longitudinally and laterally within the frame 305 for an even weight distribution. The containment region 316 is aligned with the wheels 302 along the length of the frame 305, to place the weight of any contents of the containment region over the wheels.

The containment region may be particularly suited for accommodating a water tank within, given its low and central positioning within a trailer as will be described below.

The drawbar 303 is shown in FIG. 17 in an extended position in which it is supported by the front longitudinal position for towing of the trailer 300. The front longitudinal member 314 is hollow to allow the drawbar 303 to be retracted or pushed into the member 314 when the drawbar 303 is not required to be extended, for example when the trailer is being used for display or other service purposes, and/or is lowered or is in storage.

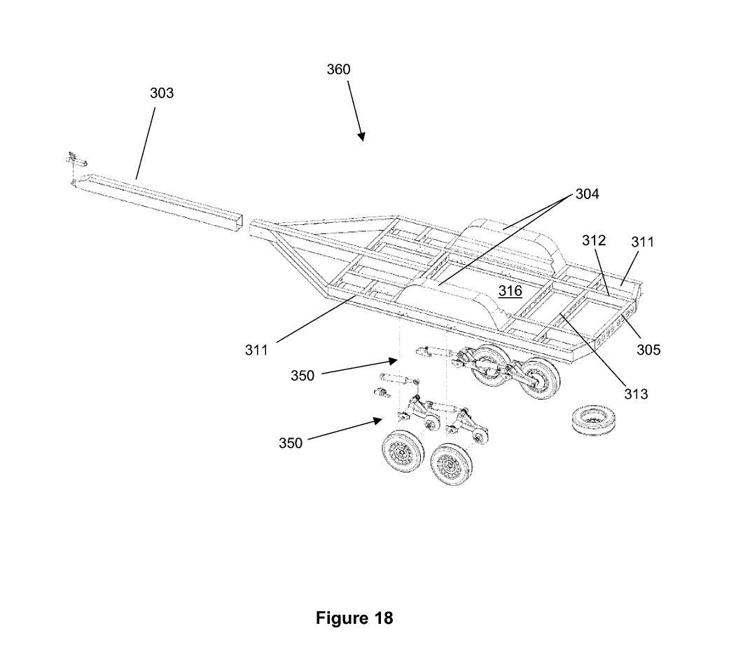

FIG. 18 shows a partially exploded view illustration of the chassis system 360, including the frame 305, drawbar 303, suspension assemblies 350 and wheels 302. In this view, both wheel arches 304 are shown on the chassis, as is the nearest outer longitudinal member 311, along with the inner longitudinal members 312, cross members 313 and containment region 316.

### Hydraulic Cylinders

The hydraulic cylinders 306 of trailer 300 are designed so that the hydraulic suspension system can fail safely in the event of a leak or burst in the hydraulic circuit.

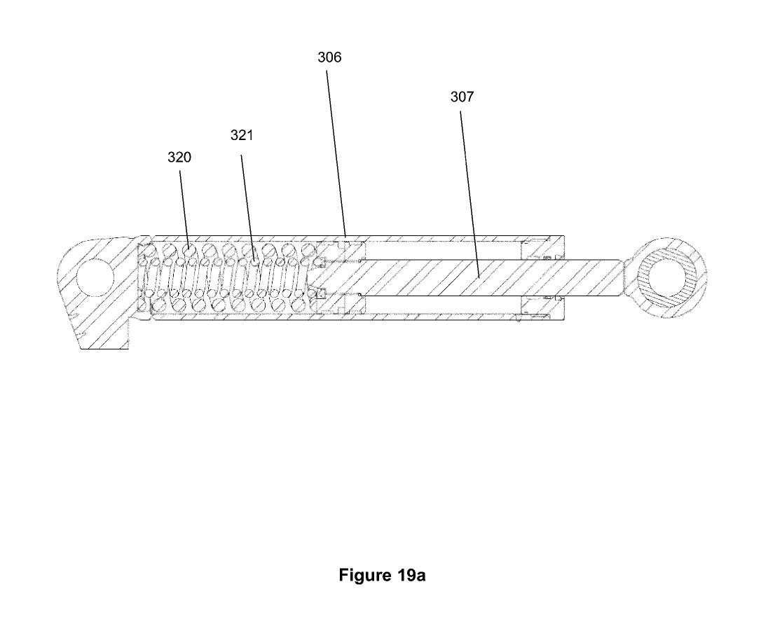

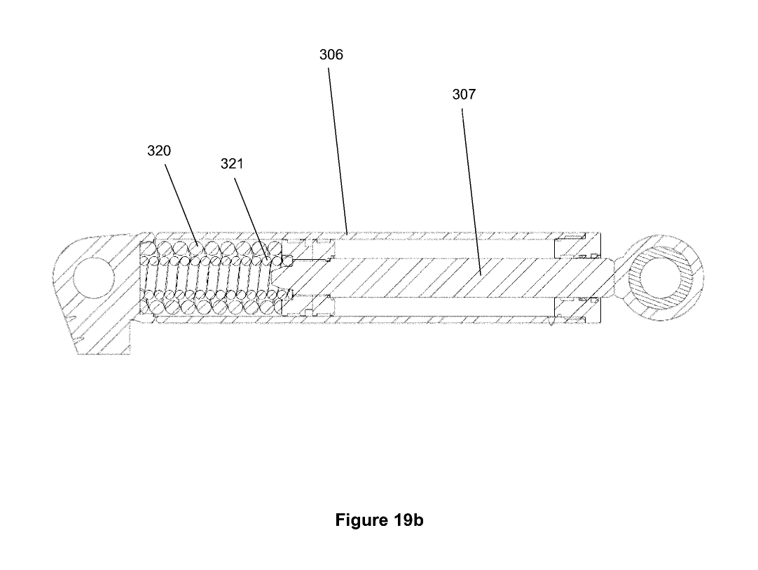

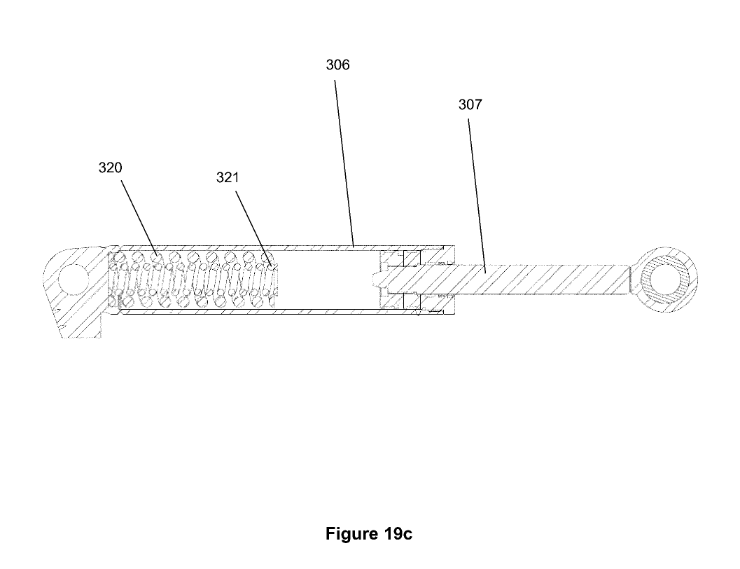

FIGS. 19a-c each show cross section views of a hydraulic piston-cylinder assembly 350, showing the piston 307 in different positions within the cylinder 306. FIG. 19a shows the piston 307 in a first position along the length of the cylinder, which is approximately half way along the length of the cylinder, in an intermediate position. In this embodiment, the first position of the piston 307 corresponds to the ride position of the frame 305 when the piston-cylinder assembly 350 is assembled on the trailer 300. FIG. 19b shows the piston 307 in a second position in which it is retracted, which in this embodiment corresponds to the lowered position of the frame. FIG. 19c shows the piston 307 in a third position in which it is extended, which in this embodiment corresponds to the raised position of the frame.

A biasing means is positioned within the cylinder 306 in addition to and acting on the piston. When the piston has compressed the biasing means, such as when the piston is in the second position in FIG. 19b, the biasing means provides a biasing force on the piston, urging it back towards the first position of the piston. The biasing means is in this embodiment is a pair of opposed helical springs, in particular, an outer helical spring 320 and an inner helical spring 321. The outer helical spring 320 and inner helical spring 321 have opposite helix directions, which advantageously prevents the coils of the helical springs from pinching each other as the springs are compressed. Implementing the springs in parallel provides a high equivalent spring constant. In the absence of a force on the springs 320 and 321 they extend only partially along the length of the cylinder 306.

When the trailer 300 is to be moved from the ride position into the lowered position, the hydraulic fluid in the hydraulic cylinder 306 forces the piston 307 towards the second position. The piston 307 compresses the springs 320, 321 until the piston reaches a predetermined limit, which may be determined by the springs reaching their maximum possible travel in compression. The force on the piston 307 due to the hydraulic pressure is therefore greater than the biasing force provided to the piston by the springs 320, 321.

When the trailer 300 is to be moved from the ride position to the raised position, the hydraulic fluid in the hydraulic cylinder 306 forces the piston 307 towards the third position. The helical springs 320, 321 reach their uncompressed length, and remain at said uncompressed length while the piston 307 travels away from the springs within the cylinder 306.

The biasing element is advantageous in the event of a hydraulic leak, burst or other malfunction which results in an unintended loss of hydraulic pressure. In absence of any safeguard, a loss of hydraulic pressure would allow the piston 307 to move into the second position, allowing the frame 305 to fall into the lowered position, which would be dangerous if it occurred while driving. The biasing element is configured to support the frame in an emergency position higher than the lowered position, if hydraulic pressure is lost, which prevents the frame 305 from falling all the way to ground level. In this embodiment, when the frame is in the emergency position, the frame is at a height lower than the ride position, but higher than the lowered position. Similarly, the piston 307 is at a position between the first position (which in this embodiment is an intermediate position) and the second position (which in this embodiment is a retracted position), due to the lack of hydraulic force assisting the spring in keeping the frame in the ride position. In other embodiments the emergency position and ride position may be the same position—that is, the biasing means is able to support the frame in the ride position in the absence of hydraulic pressure.

### Water Tank

The trailer 300 also incorporates a fluid containment device to hold both the fresh water and grey water that may be kept in the trailer—the fresh water being potable water, and the grey water being water that has been used, but is still relatively sanitary. Other fluids may also be contained in the fluid containment device.

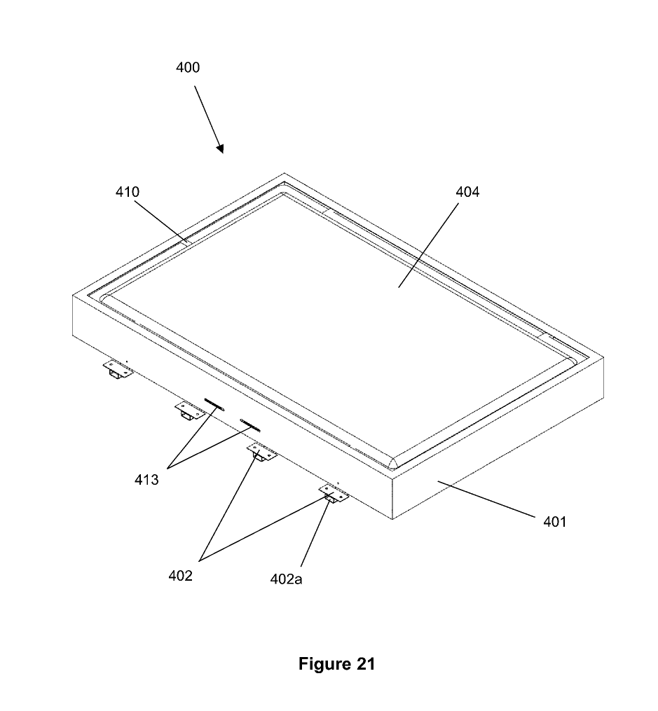

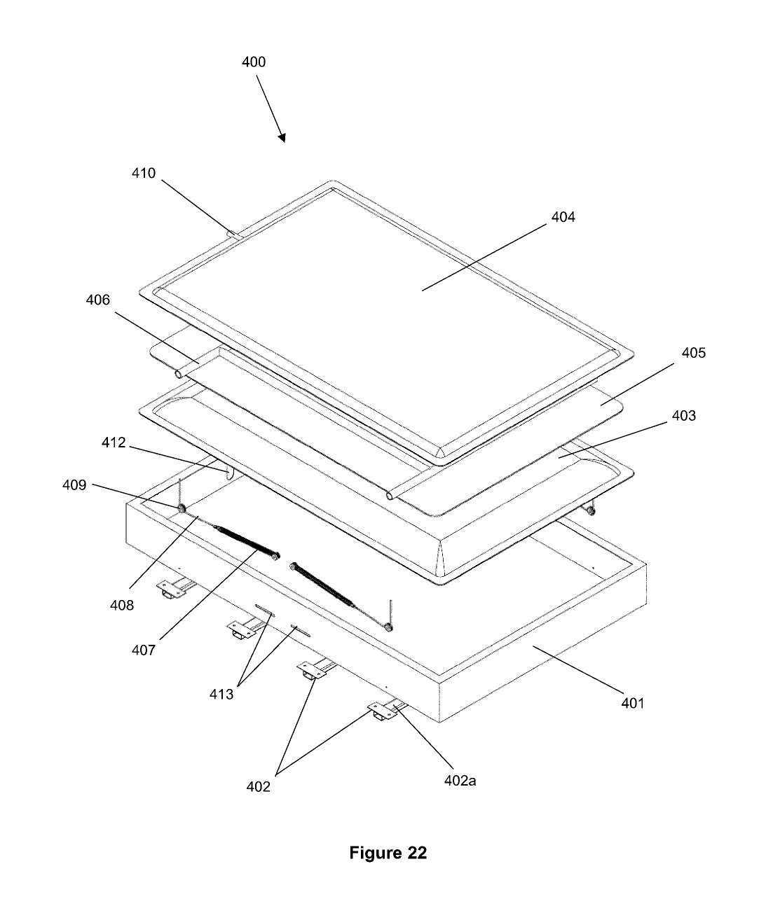

FIGS. 21-23 show a fluid containment device in the form of a water tank 400 according to one embodiment of the invention. The water tank 400 is in this embodiment shaped and sized to fit with the containment region 316 of frame 305 of trailer 300, which has been described previously. In FIGS. 21-23, no cover is shown over the top of the water tank 400. In practice, a cover may be used.

The water tank 400 comprises an outer housing 401 and mounting brackets 402 which are able to be connected to a chassis system of a trailer, for example to a frame. The mounting brackets are connected to the ends of structural members 402a which run underneath the water tank 400 to support the water tank. The specific configurations of the mounting brackets and structural members can vary depending on the shape and size of the water tank and the design of the chassis in which it is intended to mounted. In some embodiments the water tank may be mounted elsewhere in the trailer.

The water tank 400 comprises a first bladder 403 and a second bladder 404. The bladders may be formed from flexible PVC bags or other suitable flexible containment means. The first bladder 403 may be used to hold fresh water, and the second bladder 404 may be used to hold grey water. The first bladder 403 has a fluid passage 410 and the second bladder 404 has a fluid passage 411. In this embodiment the fluid passages 410 and 411 are each able to serve as a fluid inlet and a fluid outlet to the respective bladder. In other embodiments the bladders may have separate inlet and outlet passages.

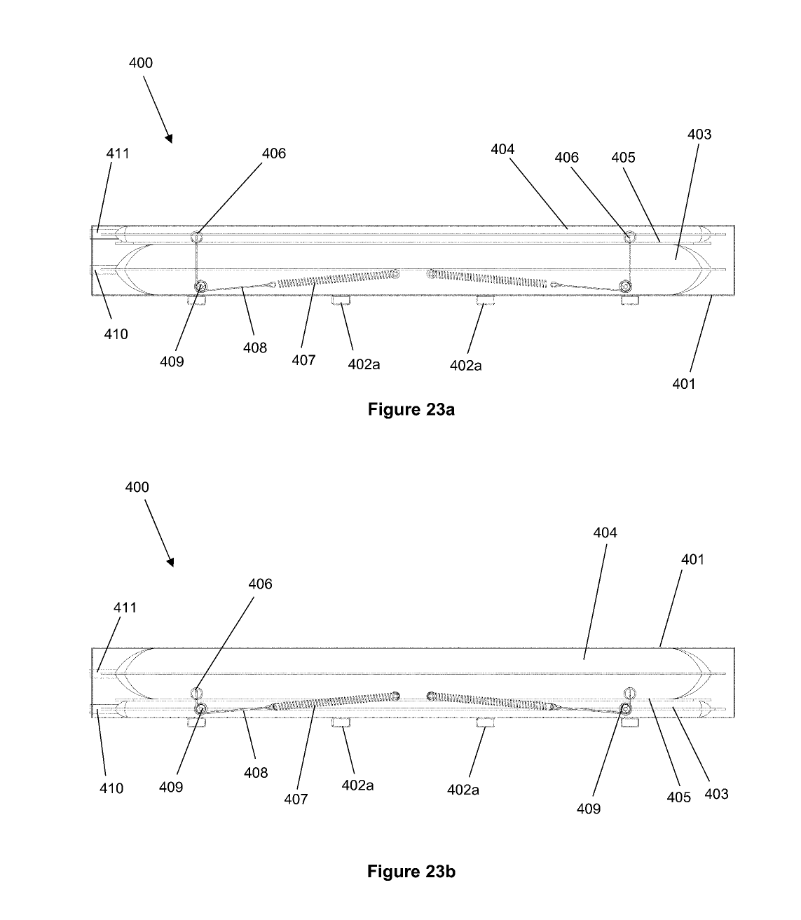

The water tank 400 also comprises a separation means, in the form of a plate 405, positioned between the first bladder 403 and second bladder 404. In this embodiment the second bladder 404 is, in use, provided above the separation means, and the first bladder 403 is below the separation means. When the first bladder 403 is substantially full with fresh water and the second bladder 404 is substantially empty (as shown FIG. 23a), the first bladder 403 occupies the vast majority of the space within the housing 401. As fresh water is used, it exits the first bladder 403 via the fluid passage 410, and the size of the first bladder 403 is reduced. If the fresh water is used for a purpose which makes it grey water, it can be collected in the second bladder 404 via the plumbing of the vehicle in which the water tank is installed. Therefore, as fresh water is used, the first bladder 403 gets smaller, making room for the second bladder 404 to expand as it fills up with collected grey water. FIG. 23b shows the configuration in which the second bladder 404 is substantially full, and the first bladder 403 is substantially empty.

The housing 401 includes an aperture in the form of a vertically oriented slot 412 for the fluid passages 410 and 411 to protrude out of the housing so that they can be connected to plumbing. In this embodiment, the two passages 410 and 411 are able to move vertically within the slot 412 as the relative sizes of the first bladder 403 and second bladder 404 change as fresh water becomes grey water. In other embodiments the inlets and/or outlets of each bladder may pass through different slots. In further embodiments the connections between the bladders and the inlets/outlets may be sufficiently flexible that the outlets do not need to move relative to the housing.

It is useful for the second bladder 404 to be above the first bladder 403, so that any weight of the second bladder and the separation plate 405 can provide a force on the first bladder 403, increasing the water pressure at the outlet of the first bladder 403, which assists in extraction of the fresh water.

The separation means may also be biased towards the first bladder 403 by a biasing means, which further increases the pressure of the water in the bladder at the fluid passage 410, assisting in extraction of the fresh water. In this embodiment, separation means comprises a frame 406 connected to the plate, and a biasing means acts on the frame to bias the separation means towards the first bladder 403.

In this embodiment the biasing means comprises four biasing assemblies, each comprising a spring 407 and a cable 408. Within each biasing assembly, one end of the cable 408 is connected to the frame 406, and the other end of the cable 408 is connected to the spring 407. The springs 407 are in this embodiment helical springs each configured to tension a cable 408. The end of each spring 407 is mounted to an anchor point on the water tank 400, so that tension in the spring 407 tensions the cable 408, providing a downwards biasing force on the frame 406.

In this embodiment each cable 408 runs over a roller 409 to change the direction of the cable 408. This allows the springs to be oriented horizontally, or at least at an oblique angle to the vertical, while the cables act substantially downwardly on the separation means. This enables each biasing assembly to fit within a small vertical space, which is advantageous when there is limited vertical space—for example when the biasing assemblies must all be located within the housing 401, and the housing itself must fit within a chassis. The rollers 409 are mounted at the bottom of the housing 401 proximate the first bladder 403, to provide for a long range of travel of the separation means.

If the first bladder 403 is to be filled, it is helpful to be able to disable the biasing means, otherwise the bias would need to be overcome by pumping fresh water into the first bladder. In this embodiment the housing 401 comprises slots 413 through which the anchor points of the springs 407 can be accessed. The tension in the springs can then be released by a bias-release means, such as a quick release mechanism (not shown), which allows the anchor points to be moved within the slots towards the rollers 409, to release the tension in the springs 407 and reduce or eliminate the bias on the separation means. To re-apply the bias once the first bladder 403 has been filled, the bias-release means can be operated to move the spring anchor points away from the rollers to reapply tension on the separation means.

In other embodiments, the bias may not be releasable, and the first bladder is able to be filled by pumping the water into the first bladder, or injecting it in from a pressurised source.

### Alternative Embodiments

While the embodiments described with reference to the Figures comprise trailers, various aspects of the invention could be applied to a truck or other vehicle, regardless of whether or not the vehicle is able to be driven or towed or otherwise. A vehicle for the purposes of this invention may be a towed vehicle, for example a trailer, or a powered vehicle, for example a truck.

In one embodiment of the invention, the vehicle may be a boat or other type of floating vehicle. In such an embodiment, the boat may have lower panels with buoyant means attached to their lower sides such that the lower panels can fold down and rest on the water's surface while be able to support loads.

Various features may be present on a trailer or vehicle within the scope of the invention such as additional doors or hatches, windows, lights, screens etc.

In some embodiments the upper panel may provide only cover for part of the platform, or may be extendable or retractable such that the amount of overhead cover can be adjusted. The upper panel may therefore be substantially the same size as the opening in the closed configuration but able to be retracted or folded back on itself while in the open configuration to allow the user a choice regarding the extent of cover that they would like.

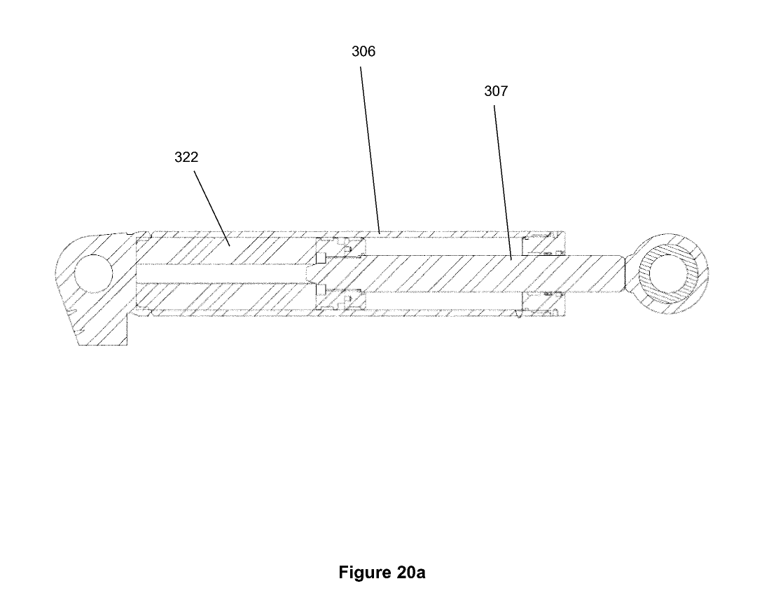

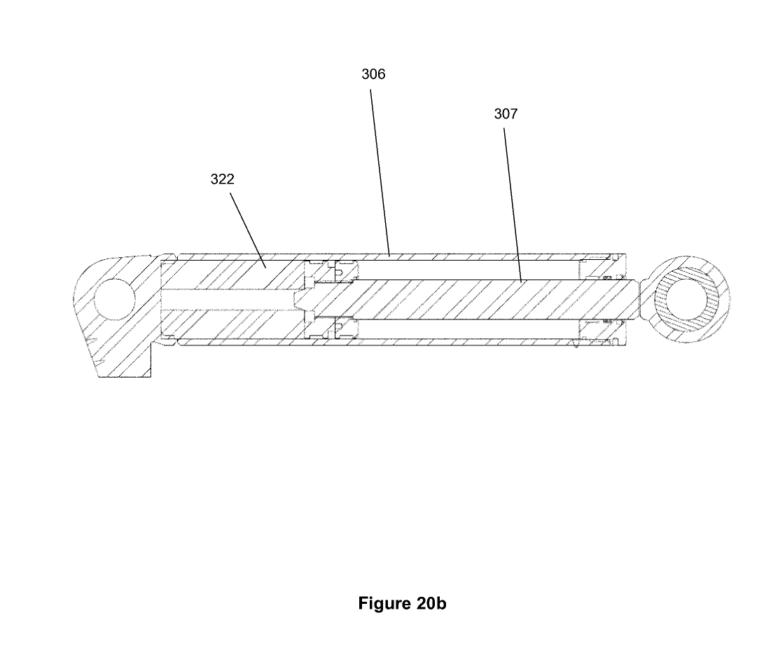

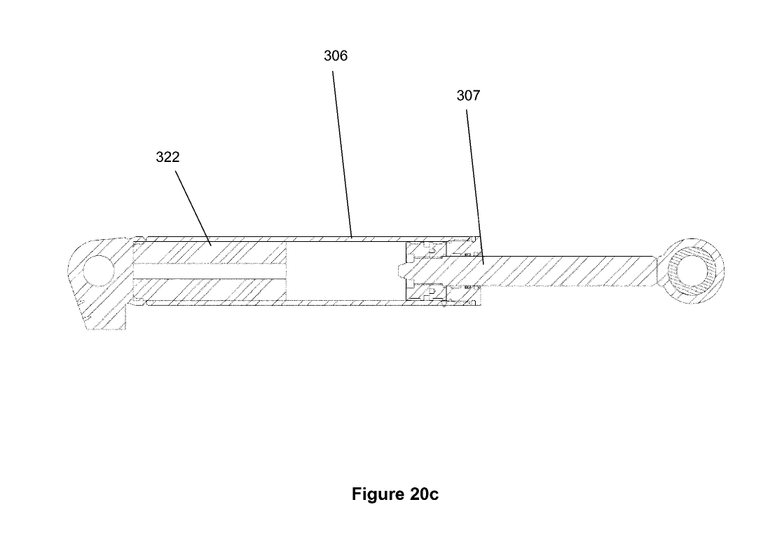

In some embodiments the biasing element within a cylinder of the suspension system may be one or more polymer springs, such as a polyurethane spring. FIGS. 20a-c show a piston-cylinder assembly including cylinder 306 and piston 307, but with a polyurethane spring 322 in place of the helical springs. The polyurethane spring 322 may be a number of a polyurethane springs in series to achieve an appropriate spring constant.

In some embodiments the biasing element may be incorporated into a design in which the trailer is only adjustable between a ride position and a lowered position, rather than also between a ride position and a raised position. In this case the frame may not prevent the wheels from being removed from the wheel mounts in the ride position.

Unless the context clearly requires otherwise, throughout the description and the claims, the words “comprise”, “comprising”, and the like, are to be construed in an inclusive sense as opposed to an exclusive or exhaustive sense, that is to say, in the sense of “including, but not limited to”.

The entire disclosures of all applications, patents and publications cited above and below, if any, are herein incorporated by reference.

Reference to any prior art in this specification is not, and should not be taken as, an acknowledgement or any form of suggestion that that prior art forms part of the common general knowledge in the field of endeavour in any country in the world.

The invention may also be said broadly to consist in the parts, elements and features referred to or indicated in the specification of the application, individually or collectively, in any or all combinations of two or more of said parts, elements or features.

Where in the foregoing description reference has been made to integers or components having known equivalents thereof, those integers are herein incorporated as if individually set forth.

It should be noted that various changes and modifications to the presently preferred embodiments described herein will be apparent to those skilled in the art. Such changes and modifications may be made without departing from the spirit and scope of the invention and without diminishing its attendant advantages. It is therefore intended that such changes and modifications be included within the present invention.

1. A chassis system for a vehicle, the chassis system comprising:
a frame configured to support a body of the vehicle, the frame comprising a pair of outer longitudinal members defining outer lateral sides of the chassis system;
a plurality of wheel mounts; and
one or more suspension systems connected between each of the plurality of wheel mounts and the frame,
wherein each wheel mount is configured to receive a wheel such that the chassis system is supported on at least one pair of the wheels,
wherein the frame is configured such that each pair of wheels comprises one wheel on each lateral side of the vehicle, the outer longitudinal members being positioned on the outside of and adjacent to the wheels when the frame is in a ride position; and
wherein the one or more suspension systems are configured to selectively vary the height of the frame between the ride position and a raised position in which the outer longitudinal members are at a height above the top of the wheels.

2. The chassis system of claim 1, wherein when the frame is in the ride position, the outer longitudinal members prevent the wheels from being removed from the wheel mounts and, when the frame is in the raised position, the wheels are able to be removed from the wheel mounts.

3. The chassis system of claim 1, wherein the chassis system is configured to enable the one or more suspension systems to selectively vary the height of the frame between the ride position and a lowered position.

4. The chassis system of claim 1, wherein each outer longitudinal member is positioned adjacent a corresponding inner longitudinal member of the frame, and each wheel is positioned between one of the outer longitudinal members and the corresponding inner longitudinal member.

5. The chassis system of claim 4, wherein the frame comprises suspension arm mounting points and the one or more suspension systems comprises pivoting suspension arms pivotally mounted to the suspension arm mounting points.

6. The chassis system of claim 5, wherein the frame comprises a pair of suspension arm mounting points for each pivoting suspension arm.

7. The chassis system of claim 6, wherein each pair of suspension arm mounting points comprises a first suspension arm mounting point on one of the outer longitudinal members, and a second suspension arm mounting point on the respective corresponding inner longitudinal member, such that each pivoting suspension arm is mounted on the frame at two of the suspension arm mounting points.

8. The chassis system of claim 4, wherein the frame comprises a piston-cylinder mounting point associated with each pivoting suspension arm and the one or more suspension systems comprises a piston-cylinder assembly mounted in connection between each of the pivoting suspension arms and the respective piston-cylinder mounting points.

9. The chassis system of claim 8, wherein each piston-cylinder mounting point is spaced from the respective suspension arm mounting point to allow the piston-cylinder assemblies to lift the frame into the raised position and lower the frame into the lowered position.

10. (canceled)

11. (canceled)

12. (canceled)

13. The chassis system of claim 4 when dependent on claim 4, wherein the frame comprises a containment region bounded by the inner longitudinal members and cross members.

14. The chassis system of claim 13, wherein the containment region is aligned with the wheels along the length of the frame.

15. (canceled)

16. (canceled)

17. The chassis system of claim 1, wherein the vehicle is a trailer, and the frame comprises a front longitudinal member configured to support a drawbar of the trailer inside of the front longitudinal member.

18. (canceled)

19. The chassis system of claim 17 wherein the front longitudinal member is configured to telescopically receive the drawbar so that the drawbar is able to be moved between an extended position in which the drawbar can be used to tow the trailer, and a retracted position in which the drawbar can be stored within the frame of the trailer.

20. A vehicle comprising the chassis system of claim 1.

21. A vehicle comprising:
rolling means;
a body; and
a chassis system comprising:
a frame configured to support the body; and
a suspension system comprising one or more double-acting piston-cylinder assemblies operatively supporting the chassis system on the rolling means, the suspension system configured to selectively vary the height of the frame relative to the rolling means between a ride position and a lowered position,
wherein each of said piston-cylinder assemblies comprises a piston selectively adjustable within a cylinder between a first position corresponding to the ride position and a second position corresponding to the lowered position, and
wherein, when the piston is in the second position, a biasing means within the cylinder applies a biasing force on the piston towards the first position, the biasing force being sufficient to support the frame in an emergency position higher than the lowered position in the absence of hydraulic pressure in the cylinder.

22. The vehicle of claim 21, wherein the suspension system is also configured to selectively vary the height of the frame between the ride position and a raised position.

23. The vehicle of claim 22, wherein the piston of each piston-cylinder assembly is also selectively adjustable within the cylinder between the first position and a third position, the third position corresponding to the raised position of the frame.

24. The vehicle of claim 23, wherein the rolling means comprises one or more pairs of wheels, each pair comprising one wheel on either side of the vehicle, and each piston-cylinder assembly is configured to vary the height of a single wheel of the one or more pairs of wheels relative to the frame.

25. The vehicle of claim 24, wherein the suspension system comprises one or more pivoting suspension arms on which the wheels are mounted, and each piston-cylinder assembly acts on one of the pivoting suspension arms.

26. The vehicle of claim 21, wherein the biasing means comprises at least one compression spring and, in the absence of a force on the at least one compression spring, the at least one compression spring extends only partially along the length of the cylinder.

27-40. (canceled)
